(19) United States
(12) Patent Application Publication
(10) Pub. No.: US 2023/0298004 A1
(43) Pub. Date: Sep. 21, 2023

(54) STORE SYSTEM, INFORMATION PROCESSING DEVICE, AND CONTROL METHOD

(71) Applicant: Toshiba Tec Kabushiki Kaisha, Tokyo (JP)

(72) Inventors: Kenya HIRAMATSU, Kita Tokyo (JP); Tsuyoshi GOTANDA, Ota Tokyo (JP)

(21) Appl. No.: 18/175,322

(22) Filed: Feb. 27, 2023

(30) Foreign Application Priority Data
Mar. 17, 2022 (JP) 2022-042939

(51) Int. Cl. G06Q 20/36; G06Q 20/10

(52) U.S. Cl. CPC G06Q 20/363; G06Q 20/102

(57) ABSTRACT

According to one embodiment, a store system includes an access point to connect to an information terminal that is operated by a customer on a sales floor, a settlement terminal to process payments for merchandise registered by the customer for purchase using the information terminal, and a mobile controller. The mobile controller is connected to the access point and configured to acquire sales data for the merchandise registered by the customer for purchase using the information terminal and preprocessing data from the information terminal. The mobile controller outputs an accounting code to the information terminal. The accounting code causes the settlement terminal to begin a settlement process when read by the settlement terminal. The mobile controller provides the sales data and the preprocessing data to the settlement terminal after the reading of the accounting code by the settlement terminal.

### CROSS-REFERENCE TO RELATED APPLICATION

This application is based upon and claims the benefit of priority from Japanese Patent Application No. 2022-042939, filed Mar. 17, 2022, the entire contents of which are incorporated herein by reference.

### FIELD

Embodiments described herein relate generally to a store system including an information terminal and a settlement terminal, an information processing device for such a store system, and a control method for an information processing device for a store system.

### BACKGROUND

When a customer purchases merchandise on a sales floor, there is a system for performing a registration operation using an information terminal such as a smart phone or a tablet terminal. The smart phone or tablet terminal can be used by the customer for scanning a barcode attached to an item to be purchased. Such a merchandise registration system is known as a self-service-type merchandise registration system. By introducing such a self-service-type merchandise registration system to a supermarket or the like where a sales floor and a cashier area are separated, a merchandise registration operation with a cashier in the cashier area is not required, and thus there is a potential advantage with such systems in relieving congestion at the cashier area.

In addition, a self-service-type settlement terminal to be operated by a customer can be placed in the cashier area. In a store where the self-service-type merchandise registration system has been introduced, the addition of a self-service type settlement terminal provides a full-self-service type system in which a customer performs all operations from merchandise registration to settlement (payment) processing without need for a cashier or store clerk.

However, while an information terminal may be provided by each customer for individual use, the settlement terminal(s) must still be shared by a plurality of customers. Therefore, if a customer occupies a settlement terminal for a long period of time, there is a concern that other customers will have to wait for the settlement terminal to become available. Such a problem also occurs in the context of other types of equipment or apparatuses that are shared by a plurality of customers. For example, equipment such as a kiosk or the like provided for adding money to an electronic money account or electronic money card.

### BRIEF DESCRIPTION OF THE DRAWINGS

FIG. 1 is a block diagram illustrating a schematic configuration of a store system.

FIG. 2 is a schematic diagram of a main data structure of an electronic money record.

FIG. 3 is a block diagram of an information terminal.

FIG. 4 is a block diagram of an electronic money charger.

FIG. 5 is a block diagram of a settlement terminal.

FIG. 6 is a block diagram of a mobile controller.

FIGS. 7 to 11 are flowcharts for a procedure executed by a processor of an information terminal.

FIGS. 12 to 19 are flowcharts for a procedure executed by a processor of a mobile controller.

FIG. 20 is a flowchart of a procedure executed by a processor of an electronic money charger.

FIG. 21 and FIG. 22 are flowcharts of a procedure executed by a processor of a settlement terminal according to a program.

FIG. 23 is a schematic diagram illustrating a registration screen displayed on a touch panel of an information terminal.

FIG. 24 is a schematic diagram illustrating a deposit amount designation screen displayed on a touch panel of an information terminal.

FIG. 25 is a schematic diagram illustrating a first payment method designation screen displayed on a touch panel of an information terminal.

FIG. 26 is a schematic diagram illustrating an insufficient balance notification screen displayed on a touch panel of an information terminal.

FIG. 27 is a schematic diagram illustrating a shortage processing designation screen displayed on a touch panel of an information terminal.

FIG. 28 is a schematic diagram illustrating of a second payment method designation screen displayed on a touch panel of an information terminal.

### DETAILED DESCRIPTION

At least one embodiment provides an improvement to a store system which is capable of reducing congestion by reducing an occupancy time of a customer at a device to be shared by a plurality of customers. For example, in a store where a customer performs a merchandise registration operation by using an information terminal then performs payment at a self-service type settlement terminal, at least one embodiment represents a technological improvement to an information terminal, an information processing device, or a control method of an information processing device or the like.

In general, according to one embodiment, a store system includes an access point configured to connect to an information terminal that is operated by a customer on a sales floor, a settlement terminal configured to process payments for merchandise registered by the customer for purchase using the information terminal, and a mobile controller. The mobile controller is connected to the access point and configured to: acquire sales data for the merchandise registered by the customer for purchase using the information terminal; acquire preprocessing data from the information terminal in association with the sales data; output an accounting code to the information terminal, the accounting code causing the settlement terminal to begin a settlement process when read by the settlement terminal from the information terminal; and provide the sales data and the preprocessing data to the settlement terminal after the reading of the accounting code.

Hereinafter, certain example embodiment will be described with reference to the drawings.

### Store System Configuration

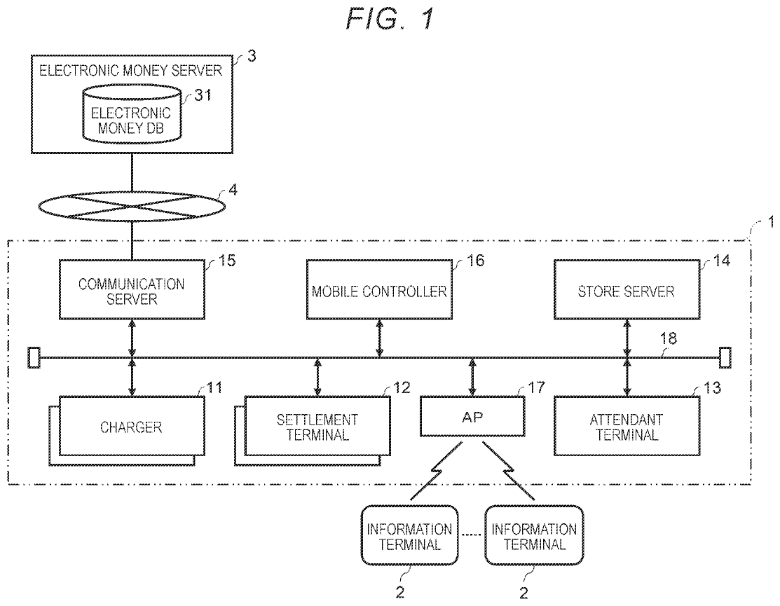

FIG. 1 is a block diagram illustrating a schematic configuration of a store system 1. The store system 1 is a system that is built in a store where a customer can use an information terminal 2 to perform a registration operation on merchandise to be purchased. In the store system 1 of this kind, for example, a smart phone possessed by a consumer to be a customer, a mobile terminal lent by a customer possessed by the store, or a tablet-type cart terminal attached to the shopping cart may be used as the information terminal 2. In the following description, a case where a smart phone is used as the information terminal 2 is exemplified.

The store system 1 includes a charger 11, a settlement terminal 12, an attendant terminal 13, a store server 14, a communication server 15, a mobile controller 16, and an access point 17. In addition, the store system 1 includes a communication network 18 such as a Local Area Network (LAN), the charger 11, the settlement terminal 12, the attendant terminal 13, the store server 14, the communication server 15, the mobile controller 16, and the access point 17 are connected to the communication network 18, to build the store system 1. The communication network 18 may be wired or may be wireless. The wired and wireless communication networks 18 may be used in combination.

The charger 11 is a device that charges (deposits) electronic money. The charger 11 is installed, for example, on a sales floor where merchandise is displayed. The settlement terminal 12 is a device that processes a price payment by a customer who purchases an item of merchandise and settles of a sales transaction of the customer. The settlement terminal 12 is referred to, for example, as a point of sales (POS) terminal, accounting machine, and the like. The settlement terminal 12 is installed in a cashier separated from the sales floor. The installation number of the charger 11 and the settlement terminal 12 is not particularly limited. The charger 11 and the settlement terminal 12 both are self-service-type devices of which customers become operators. However, the charger 11 and the settlement terminal 12 do not prevent a store clerk from being an operator. The charger 11 and the settlement terminal 12 are examples of a shared device that is shared by a plurality of customers.

The attendant terminal 13 is a device that has a function of displaying a monitoring image of the settlement terminal 12 on a display device. The attendant terminal 13 is installed near an exit of the cashier. In a location where the attendant terminal 13 is installed, a store clerk called an attendant is stationed. The monitoring image transitions in response to an operation input to the settlement terminal 12. The attendant monitors an erroneous operation, an unauthorized operation, or the like of a customer from information of the monitoring image.

The store server 14 supports overall store operations. The store server 14 manages various databases including a merchandise database. The merchandise database is a collection of merchandise records in which data for each item merchandise sold in the store is stored. Merchandise data, such as a merchandise code, a price, and a merchandise name, is included in the merchandise record. The merchandise code is a unique identification code set on a per merchandise item basis for identifying each item being sold. Generally, a barcode encoding a merchandise code is attached to each item of merchandise. In some instances, a barcode may not be attached to certain types of merchandise such as certain perishables, food items, or the like and the merchandise code may have to be entered manually.

The communication server 15 performs data communication with an external device connected to a wide area network 4 such as the Internet. According to the present embodiment, at least an electronic money server 3 is connected to the wide area network 4.

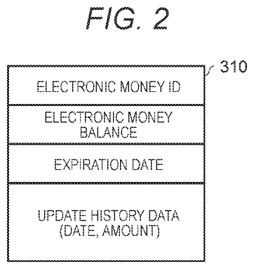

The electronic money server 3 manages electronic money possessed by a consumer registered as a member (a so-called “electronic money member”) and supports a settlement process for paying a price of the merchandise purchased by the corresponding member as a customer from the store with electronic money. The electronic money server 3 has an electronic money database 31. The electronic money database 31 is a collection of electronic money records 310 (see FIG. 2) generated on a per electronic money member basis.

FIG. 2 is a schematic diagram illustrating a main data structure of the electronic money record 310. As illustrated, the electronic money record 310 has data items such as electronic money ID, an electronic money balance, an expiration date, and an update history. The electronic money ID is a unique ID set on a per electronic money member basis. The electronic money member possesses an electronic money card on which information associated with their electronic money ID is recorded. Otherwise, the electronic money member installs an electronic money application (application software) that can display a barcode or a two-dimensional code associated with their electronic money ID to the information terminal 2.

The electronic money balance is an amount of electronic money possessed by the electronic money member. The electronic money member can increase an amount of the balance to the upper limit amount by charging electronic money by using the charger 11, the settlement terminal 12, or the like.

The expiration date is the last day of the period during which electronic money can be used. Most electronic money has an expiration date such as 5 or 10 years from the date of last use. The expiration date is updated with the date of use as the start, whenever the electronic money is used for the payment of the price. If the expiration date is not set for the electronic money, the data of the expiration date is omitted.

The update history data includes usage history data of the payment of the price of the sales transaction by using the electronic money and charging history data of the charging of the electronic money. The usage history data includes a date when the price is paid and an amount of the payment. The charging history data includes a date when the electronic money is charged and a charged amount.

The description refers back to FIG. 1.

The access point 17 is a device that receives a connection request from the information terminal 2 as a terminal of the communication network 18 and relays communication to a device in the communication network 18. The access point 17 is installed in a store so that a connection request from the information terminal 2 is received throughout the sales floor. The plurality of access points 17 may be distributed and installed in the store so as not to cause blind spots in communication.

The mobile controller 16 is a computer that performs bidirectional data communication with the information terminal 2 (connected via the access point 17) and processes information so that the corresponding information terminal 2 functions as a merchandise registration machine. The mobile controller 16 is an example of an information processing device.

Next, hardware configurations of the information terminal 2, the charger 11, the settlement terminal 12, and the mobile controller 16 are described.

### Configuration of Information Terminal

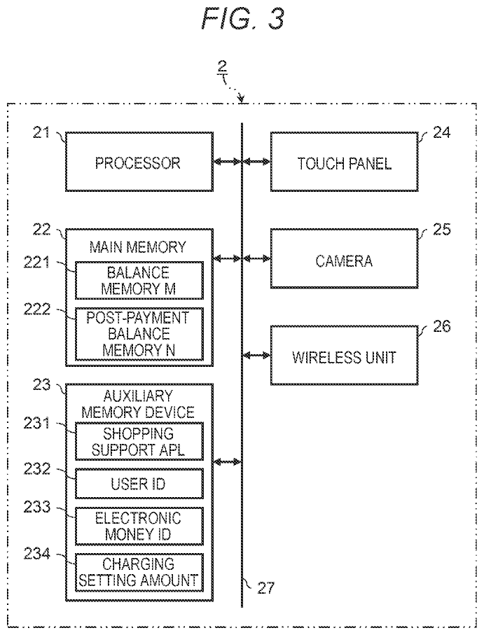

FIG. 3 is a block diagram of the information terminal 2. The information terminal 2 includes a processor 21, a main memory 22, an auxiliary memory device 23, a touch panel 24, a camera 25, a wireless unit 26, a system transmission path 27, and the like. The system transmission path 27 includes an address bus, a data bus, a control signal line, and the like. The system transmission path 27 connects the processor 21 and other units directly or via a signal input/output circuit and transmits a data signal transmitted and received therebetween.

The processor 21 controls each unit so that various functions of the information terminal 2 can be implemented according to an operating system or an application program. The processor 21 is, for example, a central processing unit (CPU).

The main memory 22 includes a non-volatile memory area and a volatile memory area. The main memory 22 stores an operating system or an application program in a non-volatile memory area. The main memory 22 may store data required by the processor 21 for executing a process for controlling each unit, in a non-volatile or volatile memory area. The main memory 22 uses the volatile memory area as a work area to which data is appropriately rewritten by the processor 21. The non-volatile memory area is, for example, a read only memory (ROM). The volatile memory area is, for example, a random access memory (RAM).

The auxiliary memory device 23 may be an electric erasable programmable read-only memory (EEPROM) or an SD memory card. The auxiliary memory device 23 stores data used by the processor 21 for executing various processes, data generated by a process of the processor 21, and the like. The auxiliary memory device 23 may store an application program.

The touch panel 24 is a device including both an input device and a display device. The touch panel 24 displays information to the operator of the information terminal 2 and receives an operation input by the operator. The operator is typically a customer who does the shopping at the store.

The camera 25 is an image capturing device mounted on the information terminal 2. The camera 25 operates, by an application program installed on the information terminal 2, as an imaging device capturing a still image or a moving image or a scanning device for obtaining a data code such as a barcode or a two-dimensional code. The camera 25 is an example of a code reader.

The wireless unit 26 is a circuit for performing data communication according to a wireless LAN communication protocol with the access point 17.

The information terminal 2 has a shopping support program 231 in the auxiliary memory device 23 to be used in the store system 1. The shopping support program 231 is a type of application software and is installed in the information terminal 2 over the Internet or otherwise. The information terminal 2 uses a portion of the storage area of the auxiliary memory device 23 as a user ID area 232, an electronic money ID area 233, and a charging setting amount area 234. In addition, the information terminal 2 uses a portion of the volatile memory area in the main memory 22 as a balance memory 221 and a post-payment balance memory 222.

The user ID area 232 is an area for storing a unique user ID set on a per user basis for identifying each user (referred to as a consumer, a customer, an electronic money member, or the like) of the information terminal 2. Different user IDs are stored in the user ID area 232 in the respective information terminals 2 in which the shopping support programs 231 are installed. The user ID stored in the user ID area 232 of one information terminal 2 is not overlapped with the user ID stored in the user ID area 232 of the other information terminal 2.

The electronic money ID area 233 is an area for storing the electronic money ID set on a per electronic money member basis. Examples of the functions of the shopping support program 231 include a linking function for associating their electronic money (e.g., an electronic money account or the like) with the shopping support program 231 (or corresponding user ID). The electronic money member as the user of the information terminal 2 registers their electronic money ID by using the linking function so that the electronic money ID will be stored in the electronic money ID area 233.

The charging setting amount area 234 is an area for storing a charging setting amount of the electronic money. Examples of the functions of the shopping support program 231 when linked to the electronic money include a charging notification function. The charging notification function prompts the electronic money member to perform charging if a balance of the electronic money is some amount (the charging setting amount) or less. Any value can be set as the charging setting amount and may be adjusted by the electronic money member. For example, an electronic money member who desires to set a charging notification for when the balance is 1,000 yen or less may set “1,000 yen” as the charging setting amount. For example, an electronic money member who desires a notification when the balance reaches 0 yen may set “0 yen” as the charging setting amount.

The balance memory 221 is an area for storing a balance (initial balance) of the electronic money for the shopping support program 231 before the electronic money member does any shopping at the store with the information terminal 2. The post-payment balance memory 222 is an area for storing a balance under the assumption that the electronic money member will pay the price of merchandise purchased at the store with the electronic money.

### Configuration of Charger

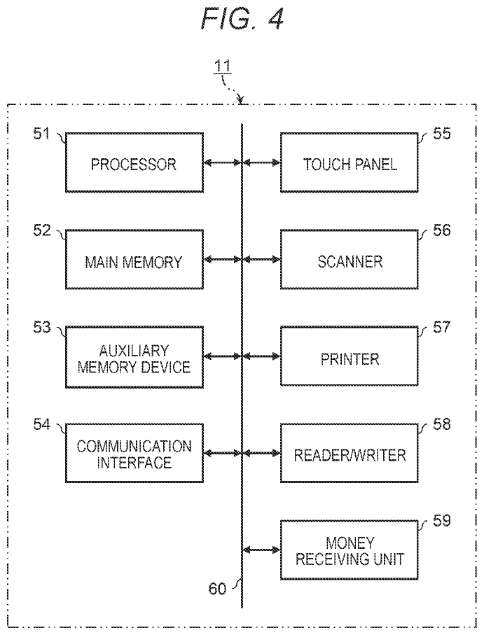

FIG. 4 is a block diagram of the charger 11. The charger 11 includes a processor 51, a main memory 52, an auxiliary memory device 53, a communication interface 54, a touch panel 55, a scanner 56, a printer 57, a reader/writer 58, a money receiving unit 59, a system transmission path 60, and the like. The system transmission path 60 includes an address bus, a data bus, a control signal line, and the like. The system transmission path 60 connects the processor 51 and other units directly or via a signal input/output circuit and transmits a data signal transmitted and received therebetween.

The processor 51 controls each unit so that various functions of the charger 11 can be implemented according to an operating system or an application program. The processor 51 is, for example, a CPU.

The main memory 52 includes a non-volatile memory area and a volatile memory area. The main memory 52 stores an operating system or an application program in a non-volatile memory area. The main memory 52 may store data required by the processor 51 for executing a process for controlling each unit, in a non-volatile or volatile memory area. The main memory 52 uses the volatile memory area as a work area to which data can be appropriately rewritten by the processor 51. The non-volatile memory area is, for example, a ROM. The volatile memory area is, for example, a RAM.

The auxiliary memory device 53 may be an electric erasable programmable read-only memory (EEPROM), a hard disk drive (HDD), a solid-state drive (SSD), or the like. The auxiliary memory device 53 stores data used by the processor 51 for executing various processes, data generated by a process of the processor 51, and the like. The auxiliary memory device 53 may store an application program.

The communication interface 54 is a circuit that performs data communication between the store server 14, the communication server 15, the mobile controller 16, and the like, which are connected to each other via the communication network 18.

The touch panel 55 is a device including both an input device and a display device. The touch panel 55 displays information to the operator of the charger 11 and receives an operation input by the operator. The operator is typically a customer of the electronic money member.

The scanner 56 is an example of a reading device that reads a code symbol such as a barcode and a two-dimensional code. The scanner 56 may be a type of reading a code symbol by deflection of laser light and may be a type of reading a code symbol from an image captured by an image capturing device.

The printer 57 dispenses a charge receipt by printing various character strings, images, or the like on receipt paper. The charge receipt is a receipt obtained by printing a balance of electronic money before and after the charging and a charged deposit amount. As the printer 57 of this kind, for example, a thermal printer, a dot impact printer, or the like can be used.

The reader/writer 58 has a function of reading data recorded on an electronic money card and a function of writing data to the card. If the electronic money card is formed by an IC card, the reader/writer 58 is an IC card reader/writer.

The money receiving unit 59 has a function of counting a banknote inserted from a banknote slot or a coin inserted from a coin slot for charging the electronic money on a per denomination basis and containing the banknote or coin in a safe and a function of paying out a banknote or coin by a difference amount as a change from the safe to the dispensing port if an amount of money exceeding a designated charged amount is deposited.

As the charger 11 having the corresponding hardware configuration, a well-known electronic money charger can be applied as it is.

### Configuration Description of Settlement Terminal

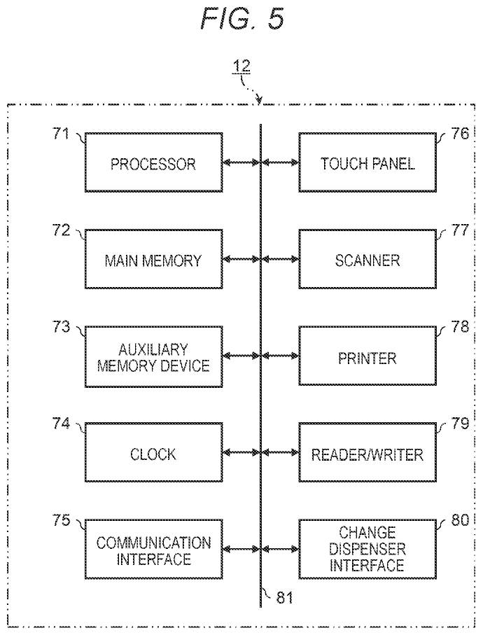

FIG. 5 is a block diagram of the settlement terminal 12. The settlement terminal 12 includes a processor 71, a main memory 72, an auxiliary memory device 73, a clock 74, a communication interface 75, a touch panel 76, a scanner 77, a printer 78, a reader/writer 79, a change dispenser interface 80, a system transmission path 81, and the like. The system transmission path 81 includes an address bus, a data bus, a control signal line, and the like. The system transmission path 81 connects the processor 71 and other units directly or via a signal input/output circuit and transmits a data signal transmitted and received therebetween.

The processor 71 controls each unit so that various functions of the settlement terminal 12 can be implemented according to an operating system or an application program. The processor 71 is, for example, a CPU.

The main memory 72 includes a non-volatile memory area and a volatile memory area. The main memory 72 stores an operating system or an application program in a non-volatile memory area. The main memory 72 may store data required by the processor 71 for executing a process for controlling each unit, in a non-volatile or volatile memory area. The main memory 72 uses the volatile memory area as a work area to which data is appropriately rewritten by the processor 71. The non-volatile memory area is, for example, a ROM. The volatile memory area is, for example, a RAM.

The auxiliary memory device 73 may be an electric erasable programmable read-only memory (EEPROM), a hard disk drive (HDD), a solid-state drive (SSD), or the like may. The auxiliary memory device 73 stores data used by the processor 71 for executing various processes, data generated by a process of the processor 71, and the like. The auxiliary memory device 73 may store an application program.

The clock 74 tracks date and time. The processor 71 processes a date and time tracked by the clock 74 as current date and time.

The communication interface 75 is a circuit that performs data communication with the store server 14, the communication server 15, the mobile controller 16, and the like connected to each other via the communication network 18.

The touch panel 76 is a device including both an input device and a display device. The touch panel 76 displays information to the operator of the settlement terminal 12 and receives an operation input by the operator. The operator is typically a customer who performs accounting (payment) for the merchandise to be purchased.

The scanner 77 is an example of a reading device that reads a code symbol such as a barcode or a two-dimensional code. The scanner 77 may read a code symbol by reflection of laser light or from an image captured by an image capturing device.

The printer 78 dispenses a purchase receipt by printing various character strings, images, or the like on the receipt paper. The purchase receipt is a receipt obtained by printing merchandise names of purchased items, prices, a total amount of money paid, and the like. As the printer 78 a thermal printer, a dot impact printer, or the like can be used. In addition, the settlement terminal 12 may have an electronic receipt function for digitizing receipt data and providing the receipt data to the customer electronically.

The reader/writer 79 has a function of reading data recorded on a medium such as a card or a smart phone and a function of writing data to the medium. The card can include a point card called an in-house point card and a common point card, in addition to cards for settlement such as a credit card, a debit card, an electronic money card, and a prepaid card. The reader/writer 79 may be any device such as a magnetic, contact-type, or non-contact-type device and may include devices of a plurality of types.

The change dispenser interface 80 configures an interface such as an automatic change dispenser (not illustrated). The change dispenser interface 80 inputs amount data of money inserted from the automatic change dispenser to the corresponding automatic change dispenser. The change dispenser interface 80 outputs change data from the settlement terminal 12 to the automatic change dispenser. The automatic change dispenser to which the change data is input automatically pays out money corresponding to the change data as the change.

The settlement terminal 12 having the corresponding hardware configuration can perform a cash settlement process of settling a sales transaction with a customer by cash inserted to the automatic change dispenser, a credit settlement process of settling a sales transaction with a credit card read by the reader/writer 79, an electronic money settlement process of settling a sales transaction with electronic money identified by the electronic money ID read by the scanner 77 or the reader/writer 79, and a code settlement process of settling a sales transaction with a barcode or two-dimensional code read by a scanner. The cash settlement process, the credit settlement process, the electronic money settlement process, and the code settlement process are well-known processes, and thus detailed descriptions are omitted.

### Configuration of Mobile Controller

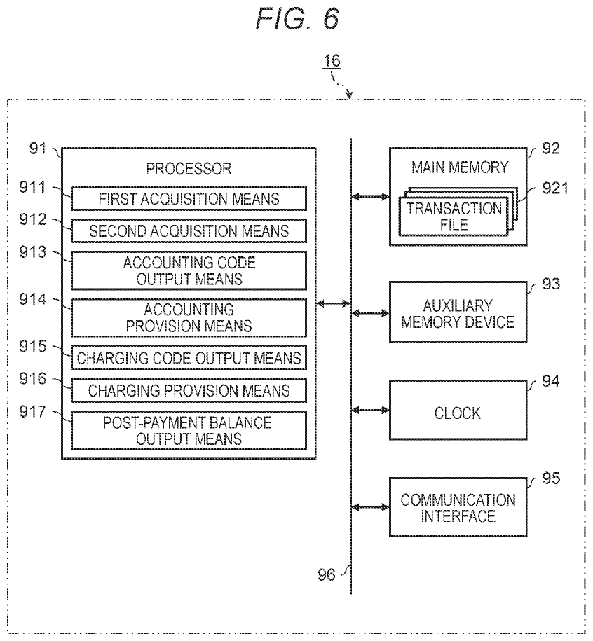

FIG. 6 is a block diagram of the mobile controller 16. The mobile controller 16 includes a processor 91, a main memory 92, an auxiliary memory device 93, a clock 94, a communication interface 95, a system transmission path 96, and the like. The system transmission path 96 includes an address bus, a data bus, a control signal line, and the like. The system transmission path 96 connects the processor 91 and other units directly or via a signal input/output circuit and transmits a data signal transmitted and received therebetween.

The processor 91 controls each unit so that various functions of the mobile controller 16 can be implemented according to an operating system or an application program. The processor 91 is, for example, a CPU.

The main memory 92 includes a non-volatile memory area and a volatile memory area. The main memory 92 stores an operating system or an application program in a non-volatile memory area. The main memory 92 may store data required by the processor 91 for executing a process for controlling each unit, in a non-volatile or volatile memory area. The main memory 92 uses the volatile memory area as a work area to which data is appropriately rewritten by the processor 91. The non-volatile memory area is, for example, a ROM. The volatile memory area is, for example, a RAM.

The auxiliary memory device 93 may be an electric erasable programmable read-only memory (EEPROM), a hard disk drive (HDD), a solid-state drive (SSD), or the like may. The auxiliary memory device 93 stores data used by the processor 91 for executing various processes, data generated by a process of the processor 91, and the like. The auxiliary memory device 93 may store an application program.

The clock 94 tracks date and time. The processor 91 processes a date and time tracked by the clock 94 as current date and time.

The communication interface 95 is a circuit that performs data communication with the charger 11, the settlement terminal 12, the attendant terminal 13, the store server 14, the communication server 15, the access point 17, and the like connected to each other via the communication network 18.

The mobile controller 16 uses a portion of the volatile memory area of the main memory 92 as the storage area of a transaction file 921. The transaction file 921 is a data file generated for each customer who does the shopping by using the information terminal 2. The data stored in the transaction file 921 is clearly described in the operation description below.

In addition, the mobile controller 16 installs control programs so that the processor 91 has functions as first acquisition means 911, second acquisition means 912, accounting code output means 913, first provision means 914, charging code output means 915, second provision means 916, and post-payment balance output means 917. The control program is a type of an application program stored in the main memory 92 or the auxiliary memory device 93. The method of installing the control program on the main memory 92 or the auxiliary memory device 93 is not particularly limited. The control program can be installed on the main memory 92 or the auxiliary memory device 93 by recording the control program on a removable recording medium or distributing the control program by the communication via the communication network 18. The recording medium can be in any form as long as the recording medium can store a program and be read by a device, like a CD-ROM or a memory card.

The first acquisition means 911 has a function of acquiring sales data of an item of merchandise purchased by the corresponding customer by the operation of the customer to the information terminal 2. The sales data of the merchandise is data including a merchandise code, a price, the number of items to be sold, a sold amount of money, and the like.

The second acquisition means 912 has a function of acquiring preprocessing data to be input to the settlement terminal 12 before accounting is processed by the operation of the customer to the information terminal 2. The preprocessing data is, for example, data relating to a payment method and data relating to the charging of the electronic money. The data relating to the charging of the electronic money may be preprocessing data to the charger 11.

The accounting code output means 913 is a function of outputting an accounting code for instructing the start of accounting of the merchandise purchased by the customer to the information terminal 2 in a form readable by the settlement terminal 12. The information terminal 2 displays the accounting code provided from the mobile controller 16 on the touch panel 24, for example, in a form of a barcode.

The first provision means 914 is a function of providing sales data acquired by the first acquisition means 911 by an operation of a customer to the corresponding information terminal 2 and preprocessing data acquired by the second acquisition means 912 to the settlement terminal 12 that reads the accounting code from the information terminal 2. The settlement terminal 12 performs a process relating to the settlement based on the sales data and the preprocessing data provided from the mobile controller 16.

The charging code output means 915 is a function of outputting the charging code for instructing the charging of the electronic money to the information terminal 2 in a form readable by the charger 11. The information terminal 2 displays the charging code provided from the mobile controller 16 to the touch panel 24, for example, in the form of the barcode.

The second provision means 916 has a function of providing data relating to the charging of the electronic money acquired as the preprocessing data by the second acquisition means 912 by the operation of the customer to the corresponding information terminal 2 to the charger 11 that reads the charging code from the information terminal 2. The charger 11 performs the process relating to the charging of the electronic money based on the data provided from the mobile controller 16.

The post-payment balance output means 917 has a function of outputting a balance after the deduction of the price of the merchandise of which the sales data is acquired by the first acquisition means 911 from the balance of the electronic money possessed by the customer to the information terminal 2. The information terminal 2 displays the balance after price deduction which is provided from the mobile controller 16 on the touch panel 24.

Details of each function are specifically described in the following operation description.

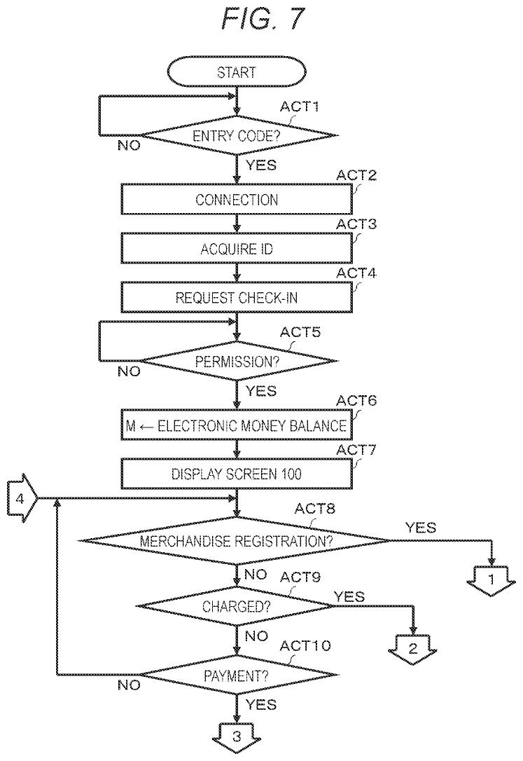

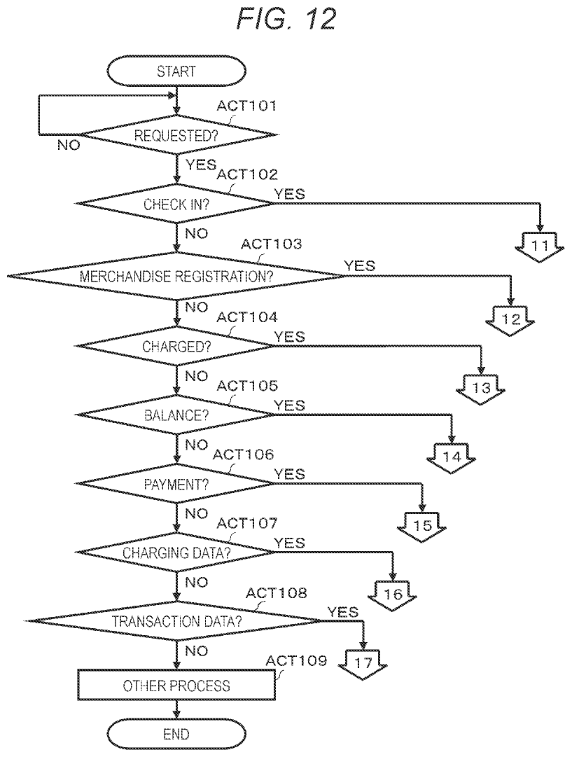

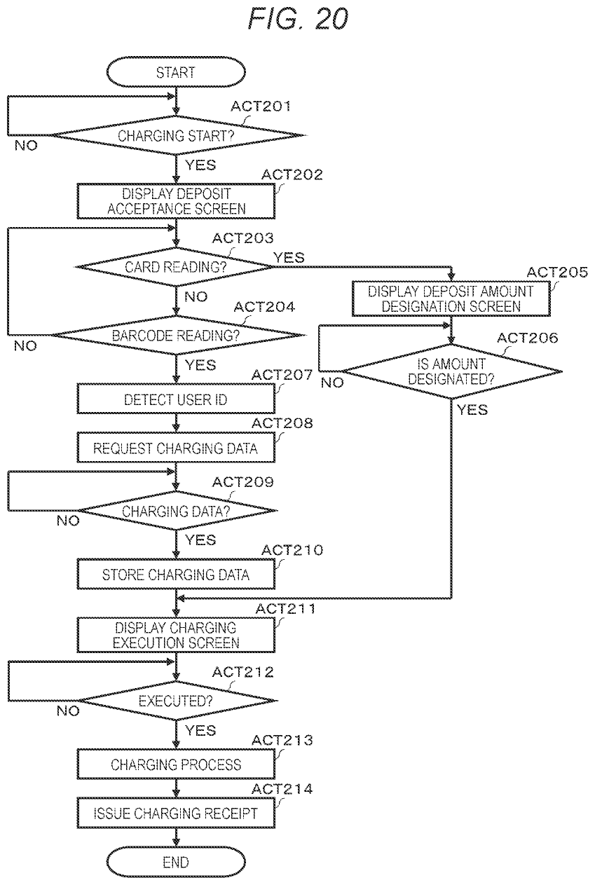

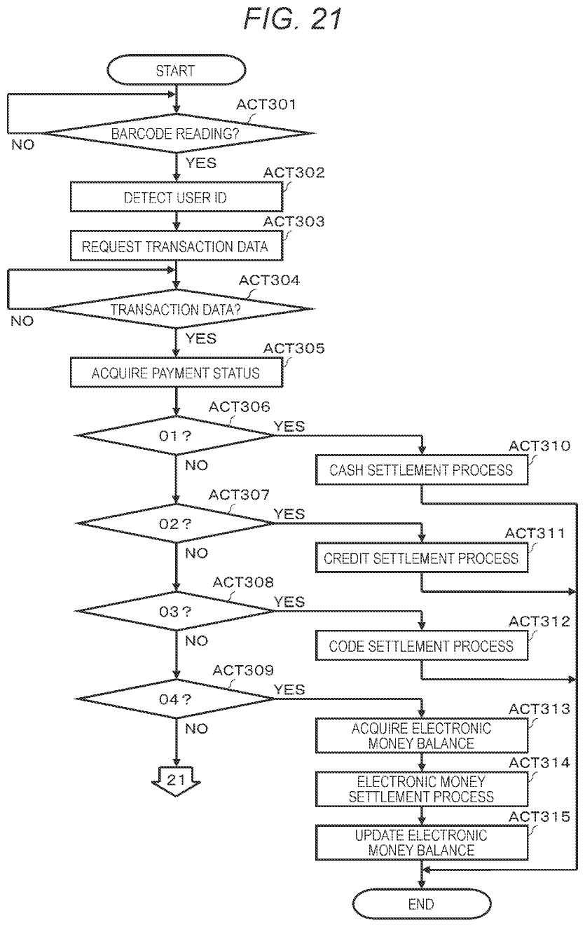

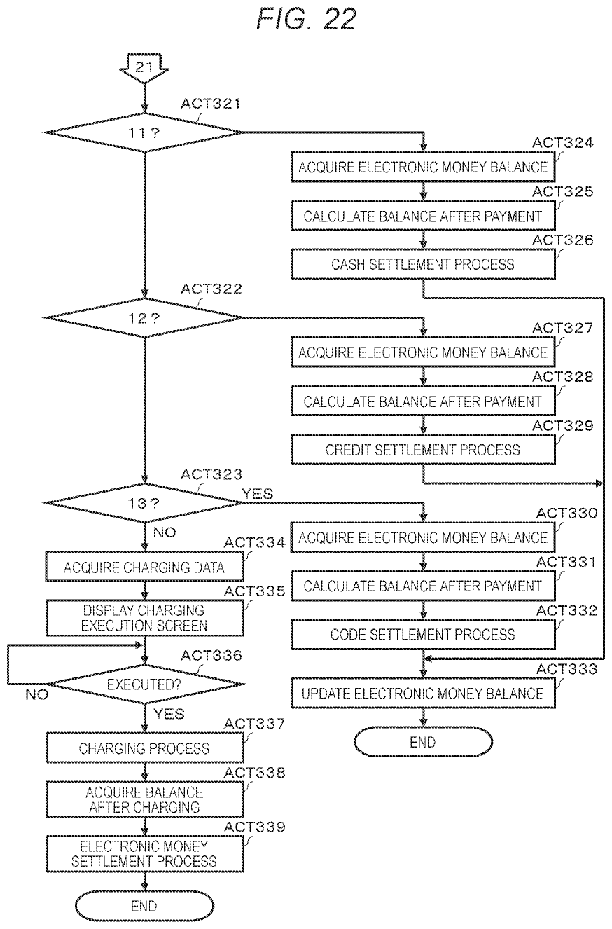

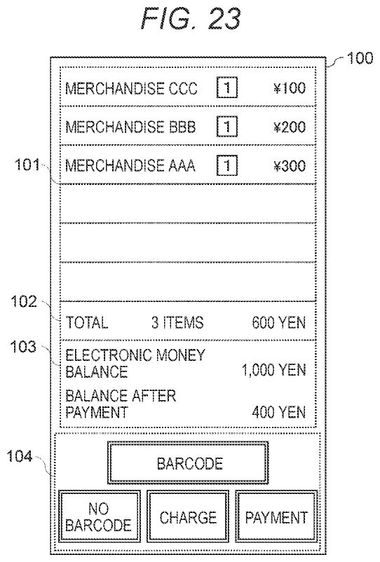

FIGS. 7 to 11 are flowcharts illustrating procedures executed by the processor 21 of the information terminal 2 according to the shopping support program 231. FIGS. 12 to 19 are flowcharts illustrating procedures executed by the processor 91 of the mobile controller 16 according to the control program. FIG. 20 is a flowchart illustrating a procedure executed by the processor 51 of the charger 11 according to a program. FIGS. 21 and 22 are flowcharts illustrating procedures executed by the processor 71 of the settlement terminal 12 according to a program. FIGS. 23 to 28 are schematic diagrams illustrating display examples of main screens displayed on the touch panel 24 of the information terminal 2. The specific content of the operations described below are examples. As long as the same effect can be achieved, operation procedures and contents are not particularly limited. In addition, layouts of the screen, text data, and the like are also examples and can be appropriately changed.

### Operation Description of Information Terminal

First, with reference to the flowcharts of FIGS. 7 to 11 and screen examples of FIGS. 23 to 28, the operations of the information terminal 2 when an electronic money member does shopping at a store by using an information terminal 2 linked to an electronic money account or the like is described.

After the shopping support program 231 starts, the processor 21 of the information terminal 2 starts the process of the procedures illustrated in the flowcharts of FIGS. 7 to 11. First, the processor 21 waits for an input of an entry code in ACT 1. The entry code is obtained by encoding the setting information relating to the store in a predetermined two-dimensional code system and is prepared, for example, at the entrance of the store. The setting information includes, for example, parameters required, for example, by the information terminal 2 for communication with the access point 17 by using the wireless LAN or information relating to operational restrictions of the information terminal 2 and the like. A customer who visits the store causes the camera 25 of the information terminal 2 to read the entry code.

After the entry code is read by the camera 25, the processor 21 controls the wireless unit 26 in ACT 2 and is connected to the access point 17 by using a wireless LAN. Also, when being connected with the access point 17, the processor 21 acquires a user ID from the user ID area 232 in ACT 3. In addition, the processor 21 acquires the electronic money ID from the electronic money ID area 233.

The processor 21 that acquires the user ID and the electronic money ID controls the wireless unit 26 to transmit a check-in request command in ACT 4. According to the control, the check-in request command is wirelessly transmitted via the wireless unit 26. The check-in request command is received by the access point 17 and is transmitted to the mobile controller 16 via the communication network 18. The user ID and the electronic money ID are included in the check-in request command.

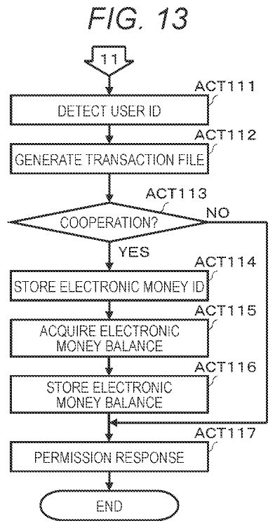

The processor 21 that transmits the check-in request command waits for a permission response command in ACT 5. As described below with reference to FIG. 13, the permission response command returns from the mobile controller 16 that receives the check-in request command. The balance of the electronic money managed by the electronic money server 3 with respect to the electronic money ID stored in the electronic money ID area 233 is included in the permission response command.

If the permission response command is received via the wireless unit 26, the processor 21 writes the balance of the electronic money included in the permission response command on the balance memory 221 in ACT 6. According to this operation, data M of the balance memory 221 becomes the balance of the electronic money if the customer enters the store. In addition, at the point in time, data N of the post-payment balance memory 222 is reset to “0”.

The processor 21 sets the screen of the touch panel 24 to a registration screen 100 (see FIG. 23) in ACT 7.

FIG. 23 is a schematic diagram illustrating one display example of the registration screen 100. As illustrated, the registration screen 100 includes a specification area 101 of registered items, a total area 102, an electronic money area 103, and an operation key area 104. The merchandise names, the number of items, amount of money due, and the like of the items registered by the operation of the information terminal 2 are displayed on the specification area 101. The customer can change the number of items by touching the area of the number of items. The amount of money is also updated according to the change in the number of items. A total number of items and the total amount for the registered items are displayed on the total area 102. The data M of the balance memory 221, that is, the balance of the electronic money before the shopping starts, and the data N of the post-payment balance memory 222, that is, the balance if it is assumed that the price of merchandise purchased by the customer is paid with the electronic money are displayed on the electronic money area 103. Accordingly, the post-payment balance before the items to be purchased are registered is 0 yen. Also, FIG. 23 illustrates the registration screen 100 after a customer (having the electronic money balance of 1,000 yen) performs the registration operation of a merchandise AAA having the unit price of 300 yen, a merchandise BBB of the unit price of 200 yen, and a merchandise CCC of the unit price of 100 yen, and the post-payment balance is updated to 400 yen.

As soft keys, a barcode key, a no-barcode key, a charge key, and a payment key are displayed on the operation key area 104. The barcode key is pressed when the customer wishes to scan a barcode of an item of merchandise with a camera of the information terminal 2. The no-barcode key is pressed when the customer wishes to register an item lacking a barcode. If the no-barcode key is pressed, a list of items without barcodes attached is displayed on the touch panel 24, and the customer selects an item of merchandise to be purchased from the list. The charge key is pressed if the customer wishes to add money to the electronic money balance by using the charger 11 during the shopping. The payment key is pressed when the customer completes shopping and wishes to pay for the registered items of merchandise.

The processor 21 displays the registration screen 100 and waits for a registration operation on an item merchandise to be purchased in ACT 8, a selection of a charge key in ACT 9, or selection of a payment key in ACT 10. The registration operation is an operation of scanning a barcode of the item to be purchased with the camera 25 after pressing a barcode key or selecting the item (without barcode) to be purchased from a list of merchandise after pressing a no-barcode key. By these registration operations, the processor 21 can acquire the merchandise codes of the merchandise to be purchased.

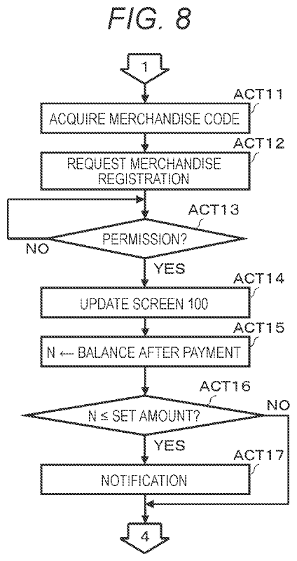

With respect to the waiting state of ACTS 8 to 10, if the registration operation of the merchandise to be purchased is performed, the processor 21 process from ACT 8 to ACT 11 of FIG. 8. The processor 21 acquires the merchandise code of the merchandise to be purchased in ACT 11. For example, if the registration operation is performed by an input of the barcode key, the merchandise code of the merchandise to be purchased is acquired from the barcode. For example, if the registration operation is performed by an input of the no-barcode key, the merchandise code of the merchandise to be purchased selected from the list is acquired.

The processor 21 that acquires the merchandise code of the merchandise to be purchased controls the wireless unit 26 to transmit a merchandise registration request command in ACT 12. According to this control, the merchandise registration request command is wirelessly transmitted via the wireless unit 26. The merchandise registration request command is received by the access point 17 and transmitted to the mobile controller 16 via the communication network 18. The user ID and the merchandise code of the item to be purchased are included in the merchandise registration request command.

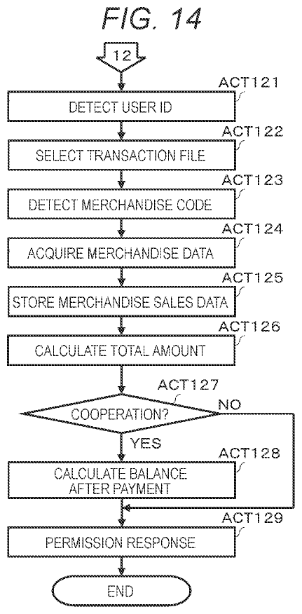

The processor 21 that transmits the merchandise registration request command waits for the permission response command in ACT 13. As described below with reference to FIG. 14, the permission response command returns from the mobile controller 16 that receives the merchandise registration request command. The data of the transaction file 921 that is generated for the customer identified by the user ID is included in the permission response command. A merchandise name of an item of merchandise to be purchased, a unit price, the number of items to be sold, a total number of items, a total amount of money, and the like are in the data of the transaction file 921. The processor 21 that receives the permission response command updates data of the specification area 101 and the total area 102 of the registration screen 100 based on the data of the transaction file 921 in ACT 14.

The post-payment balance after the price of merchandise to be purchased is deducted from the balance of the electronic money possessed by the customer is in the data of the transaction file 921. The processor 21 rewrites the data N of the post-payment balance memory 222 to the post-payment balance in ACT 15 to update the post-payment balance of the electronic money area 103. The processor 21 checks whether the post-payment balance stored in the post-payment balance memory 222 is equal to or less than the charging setting amount set in the charging setting amount area 234 in ACT 16.

If the post-payment balance is more than the charging setting amount, the processor 21 skips the process of ACT 17 and returns to the waiting state of ACTS 8 to 10 described above. In contrast, if the post-payment balance is the charging setting amount or less, the processor 21 notifies the insufficient balance in ACT 17. For example, if the “electronic money payment” is selected, the processor 21 displays a message such as “the balance is insufficient” on the registration screen 100. Thereafter, the processor 21 returns to the waiting state of ACTS 8 to 10.

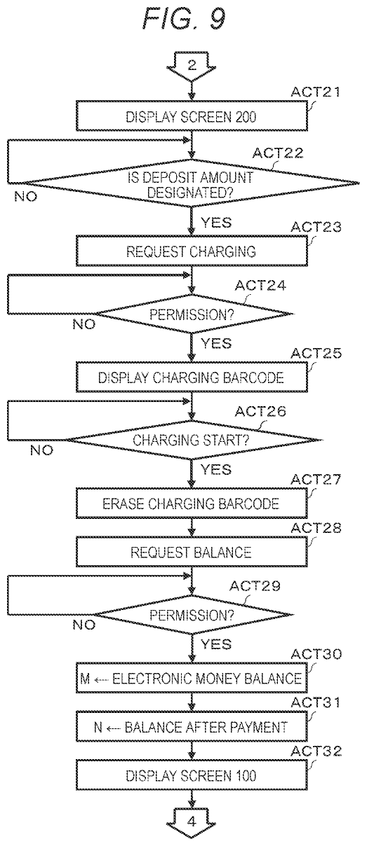

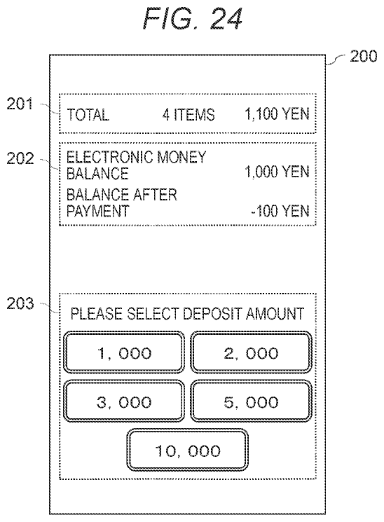

In the waiting state of ACTS 8 to 10, if the charge key is input, the processor 21 proceeds from ACT 9 to ACT 21 of FIG. 9. The processor 21 causes the screen of the touch panel 24 to be a deposit amount designation screen 200 (see FIG. 24) in ACT 21.

FIG. 24 is a schematic diagram illustrating one display example of the deposit amount designation screen 200. As illustrated, the deposit amount designation screen 200 includes a total area 201 of registered items, an electronic money area 202, and a deposit key area 203. The information as on the total area 102 and the electronic money area 103 of the registration screen 100 is displayed on the total area 201 and the electronic money area 202. For example, a soft key for designating five types of amounts of 1,000 yen, 2,000 yen, 3,000 yen, 5,000 yen, and 10,000 yen as the deposit amount, that is, a so-called deposit key is displayed on the deposit key area 203. The amount of money of the deposit key displayed on the deposit key area 203 is not limited to this. Alternatively, a desired deposit amount may be designated with a numeric keypad.

In addition, FIG. 24 illustrates the deposit amount designation screen 200 when the customer (electronic money member) who receives the notification of the insufficient balance because the customer performs the registration operation on items to be purchased worth 1,100 yen while the balance of the electronic money is only 1,000 yen, so that the post-payment balance becomes −100 yen presses the charge key. The customer selects the deposit key on which a desired deposit amount is displayed and selects the deposit amount.

The processor 21 that displays the deposit amount designation screen 200 waits for the designation of the deposit amount in ACT 22. If the deposit amount is designated by the input of the deposit key, the processor 21 controls the wireless unit 26 so that the charging request command is transmitted in ACT 23. According to this control, the charging request command is wirelessly transmitted via the wireless unit 26. The charging request command is received by the access point 17 and transmitted to the mobile controller 16 via the communication network 18. The data of the user ID and the deposit amount is included in the charging request command.

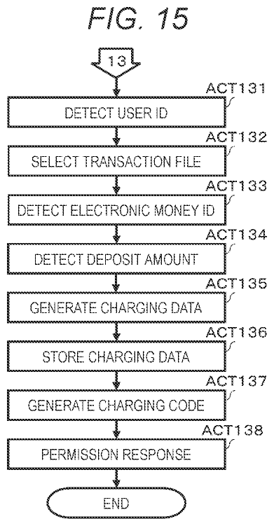

The processor 21 that transmits the charging request command waits for the permission response command in ACT 24. As described below with reference to FIG. 15, the permission response command returns from the mobile controller 16 that receives the charging request command. A charging code is included in the permission response command. The charging code is a unique code generated whenever the charging request command is received. The processor 21 that receives the permission response command displays the charge barcode indicating the charging code in the form of the barcode on the touch panel 24 in ACT 25.

The processor 21 that displays the charge barcode waits for a charging start command in ACT 26. The charge barcode is a barcode read by the scanner 56 of the charger 11. In the charger 11 that reads the charge barcode with the scanner 56, a charging process of the electronic money starts. At this time, the charging start command is transmitted from the mobile controller 16 to the information terminal 2 that sent the charging request command.

The processor 21 then erases the charge barcode of the touch panel 24 in ACT 27. In addition, the processor 21 controls the wireless unit 26 so that the balance request command is transmitted in ACT 28. According to this control, the balance request command is wirelessly transmitted via the wireless unit 26. The balance request command is received by the access point 17 and transmitted to the mobile controller 16 via the communication network 18. The user ID and the electronic money ID are included in the balance request command. The electronic money ID is stored in the electronic money ID area 233.

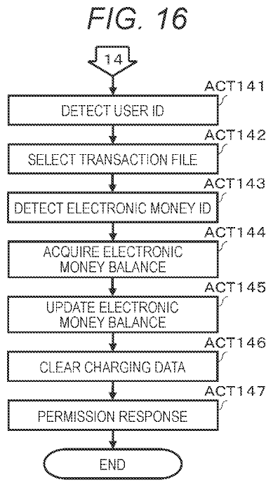

The processor 21 that transmits the balance request command waits for the permission response command in ACT 28. As described below with reference to FIG. 16, the permission response command returns from the mobile controller 16 that receives the balance request command. The balance of the electronic money managed by the electronic money server 3 with respect to the electronic money ID stored in the electronic money ID area 233, that is, the balance after the deposit amount is charged, is included in the permission response command. In addition, the data of the transaction file 921 generated for the customer identified by the user ID is included in the permission response command. The post-payment balance after the price of the merchandise to be purchased is deducted from the balance of the electronic money after the deposit amount is charged is also in the data of the transaction file 921.

If the permission response command is received via the wireless unit 26, the processor 21 writes the balance of the electronic money included in the permission response command on the balance memory 221 in ACT 30. According to this operation, the data M of the balance memory 221 becomes the balance of the electronic money after the deposit amount is charged. In addition, the processor 21 updates the data N of the post-payment balance memory 222 to the post-payment balance of the permission response command in ACT 31. If the screen of the touch panel 24 transitions to the registration screen 100 in ACT 32, the processor 21 returns to the waiting state of ACTS 8 to 10 described above. At this time, on the registration screen 100, the electronic money balance and the post-payment balance of the electronic money area 103 are updated to the data M of the balance memory 221 and the data N of the post-payment balance memory 222, respectively.

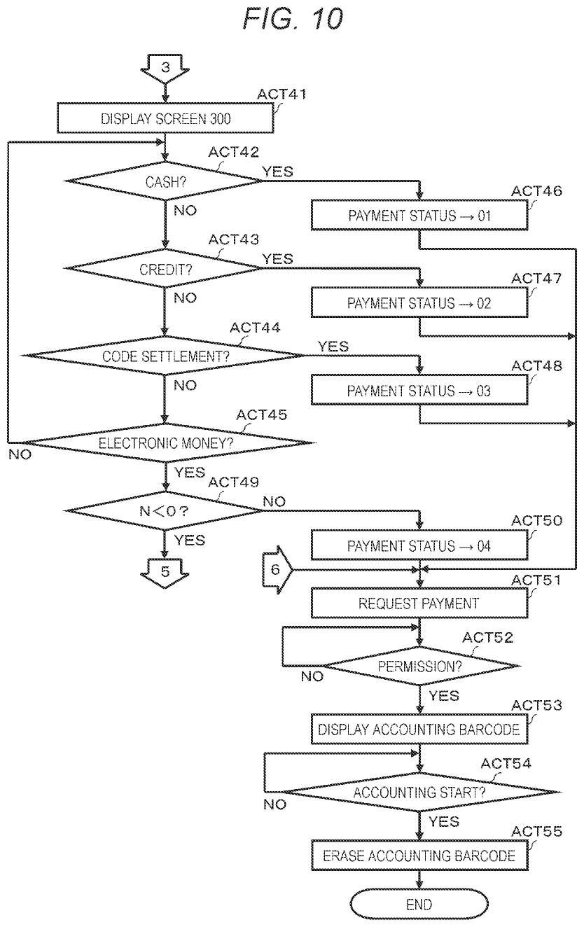

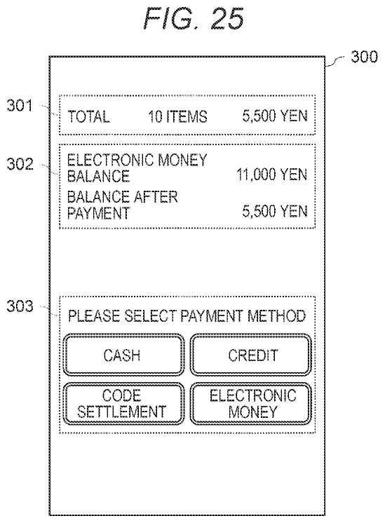

In the waiting state of ACTS 8 to 10, if the payment key is input, the processor 21 proceeds from ACT 10 to ACT 41 of FIG. 10. The processor 21 causes the screen of the touch panel 24 to be a first payment method designation screen 300 (see FIG. 25) in ACT 41.

FIG. 25 is a schematic diagram illustrating one display example of the first payment method designation screen 300. As illustrated, the first payment method designation screen 300 includes a total area 301 of registered items, an electronic money area 302, and a payment key area 303. The same information as in the total area 102 and the electronic money area 103 of the registration screen 100 are displayed in the total area 301 and the electronic money area 302. Soft keys for designating four types of payment methods of cash, a credit card, code settlement, and electronic money, that is, a so-called cash key, a so-called credit key, a so-called code settlement key, and a so-called electronic money key are displayed on the payment key area 303. Types of keys for designating the payment method are not limited thereto. Other payment method, for example, a key for designating point payment may be added. A portion of the payment method, for example, a key for designating the payment with a credit card or code settlement may be omitted.

In addition, FIG. 25 illustrates the first payment method designation screen 300 for a customer who performs the registration operation on the merchandise to be purchased of 5,500 yen while the balance of the electronic money is 11,000 yen so that the post-payment balance becomes 5,500 yen. The customer inputs the payment method key on which a desired payment method is displayed.

The processor 21 that displays the first payment method designation screen 300 waits for the designation of any one of the payment methods in ACTS 42 to 45.

In the waiting state of ACTS 42 to 45, if the cash payment is designated by the input of the cash key, the processor 21 proceeds from ACT 42 to ACT 46. The processor 21 sets the payment status for identifying the payment method to be “01” in ACT 46. If the credit card payment is designated by the input of the credit key, the processor 21 proceeds from ACT 43 to ACT 47. The processor 21 sets the same payment status to be “02” in ACT 47. If the code settlement payment is designated by the input of the code settlement key, the processor 21 proceeds from ACT 44 to ACT 48. The processor 21 sets the same payment status to be “03” in ACT 48.

In the waiting state of ACTS 42 to 45, if the electronic money payment is designated by the input of the electronic money key, the processor 21 proceeds from ACT 44 to ACT 49. The processor 21 checks whether the data of the post-payment balance memory 222 is a negative value in ACT 49. If the data of the post-payment balance memory 222 is not a negative value, that is, a full amount of the price of the merchandise to be purchased can be paid with the balance of the electronic money, the processor 21 proceeds from ACT 49 to ACT 50. The processor 21 sets the same payment status to be “04” in ACT 50.

In this manner, in the case of short tender where the full amount of the price of the merchandise to be purchased is paid with one type of payment method, if the cash payment is designated, the processor 21 sets the payment status to be “01”. If the credit card payment is designated, the processor 21 sets the payment status to be “02”. If the code settlement payment is designated, the processor 21 sets the payment status to be “03”. If the electronic money payment is designated, the processor 21 sets the payment status to be “04”.

If the payment status is determined by the process of ACT 46, 47, 48, or 50, the processor 21 proceeds to ACT 51. The processor 21 controls the wireless unit 26 so that the payment request command is transmitted in ACT 51. According to this control, the payment request command is wirelessly transmitted via the wireless unit 26. The payment request command is received by the access point 17 and is transmitted to the mobile controller 16 via the communication network 18. The user ID and the payment status are included in the payment request command.

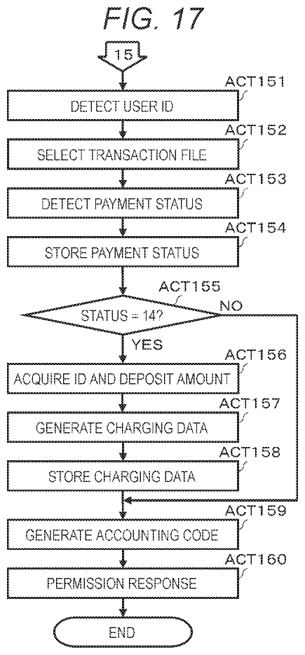

The processor 21 that transmits the payment request command waits for the permission response command in ACT 52. As described below with reference to FIG. 17, the permission response command returns from the mobile controller 16 that receives the payment request command. The accounting code is included in the permission response command. The accounting code is a unique code that is generated whenever the payment request command is received. The processor 21 that receives the permission response command displays the accounting barcode indicating the accounting code in the form of the barcode on the touch panel 24 in ACT 53.

The processor 21 that displays the accounting barcode waits for the accounting start command in ACT 26. The accounting barcode is a barcode read with the scanner 77 of the settlement terminal 12. The settlement terminal 12 that reads the accounting barcode with the scanner 77 starts the settlement process. At this time, as described below with reference to FIG. 19, the accounting start command is transmitted from the mobile controller 16 to the information terminal 2 that sent the payment request command. The processor 21 erases the accounting barcode of the touch panel 24 in ACT 55.

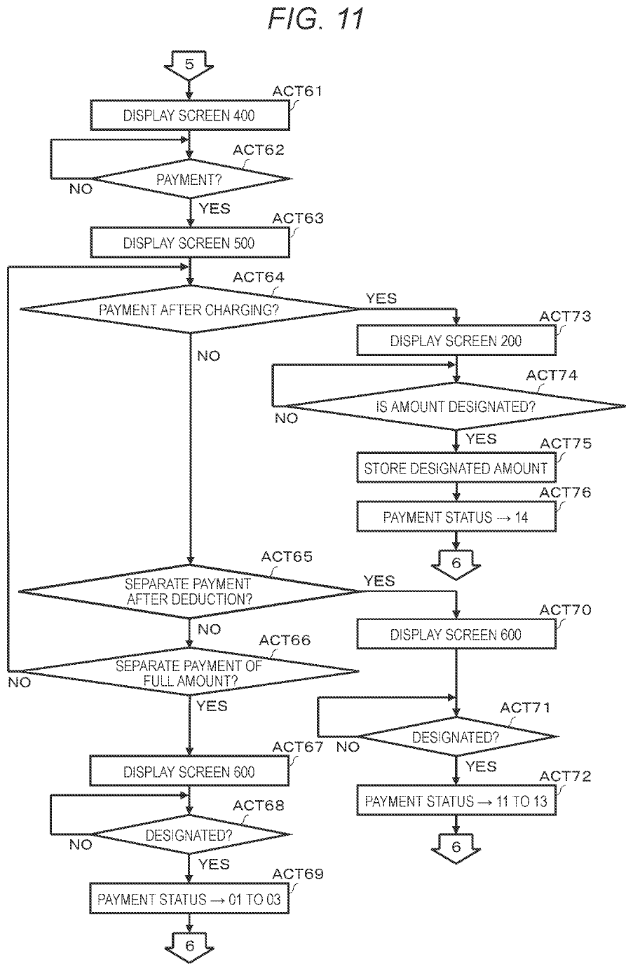

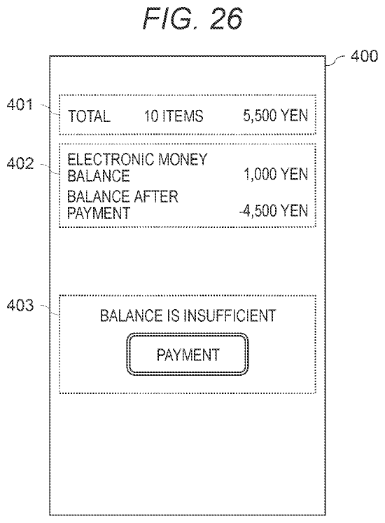

In ACT 49, if the data of the post-payment balance memory 222 is a negative value (that is, a full price of the merchandise to be purchased cannot be paid with the existing balance of the electronic money, the processor 21 proceeds from ACT 49 to ACT 61 of FIG. 11. The processor 21 causes the screen of the touch panel 24 to be an insufficient balance notification screen 400 (see FIG. 26) in ACT 61.

FIG. 26 is a schematic diagram illustrating one display example of the insufficient balance notification screen 400. As illustrated, the insufficient balance notification screen 400 includes a total area 401 of registered items, an electronic money area 402, and a payment key area 403. The same information as in the total area 102 and the electronic money area 103 of the registration screen 100 is displayed on the total area 401 and the electronic money area 402. A message for notifying that the balance of the electronic money is insufficient, a soft key for instructing continuation of the payment, that is, a so-called payment key is displayed in the payment key area 403.

In addition, FIG. 26 illustrates the insufficient balance notification screen 400 if the customer who performs the registration operation of the merchandise to be purchased by 5,500 yen while the balance of the electronic money is 1,000 yen, so that the post-payment balance of the electronic money is −4,500 yen, designates the electronic money payment with the first payment method designation screen 300 of FIG. 25. The customer who checks the insufficient balance notification screen 400 inputs the payment key.

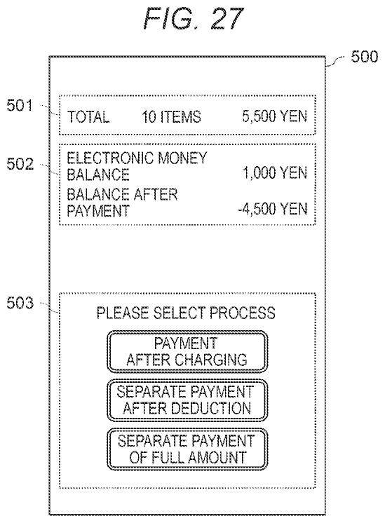

The processor 21 that displays the insufficient balance notification screen 400 waits for the input of the payment key in ACT 62. If the payment key is input, the processor 21 causes the screen of the touch panel 24 to be a shortage processing designation screen 500 (see FIG. 27) as ACT 63.

FIG. 27 is a schematic diagram illustrating one display example of the shortage processing designation screen 500. As illustrated, the shortage processing designation screen 500 includes a total area 501 of registered items, an electronic money area 502, and a shortage processing key area 503. The same information as in the total area 102 and the electronic money area 103 of the registration screen 100 is displayed in the total area 501 and the electronic money area 502. For example, soft keys for designating three types of processing methods of “payment after charging”, “separate payment after deduction”, and “separate payment of full amount”, that is, so-called shortage processing keys are displayed on the shortage processing key area 503. The “payment after charging” is a process of paying a full amount of the price of the merchandise to be purchased with the electronic money after the electronic money is charged by the insufficient amount or more. The “separate payment after deduction” is a process of paying a portion of the price with the balance of the electronic money and paying the remaining portion of the price with another payment method. The “separate payment of full amount” is a process of paying the price of the merchandise to be purchased by a payment method other than the electronic money. The customer who checks the shortage processing designation screen 500 inputs the shortage processing key of a desired processing method.

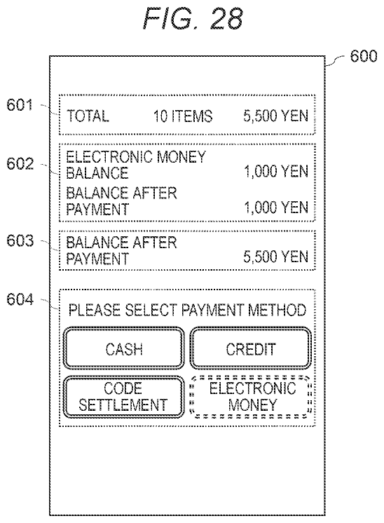

The processor 21 that displays the shortage processing designation screen 500 waits for an input of the shortage processing key of the “payment after charging” in ACT 64, an input of the shortage processing key of the “separate payment after deduction” in ACT 65, and an input of the shortage processing key of the “separate payment of full amount” in ACT 66. In the waiting states of ACTS 64 to 66, if the shortage processing key of the “separate payment of full amount” is input, the processor 21 proceeds from ACT 66 to ACT 67. The processor 21 causes the screen of the touch panel 24 to be a second payment method designation screen 600 (see FIG. 28) in ACT 67.

FIG. 28 is a schematic diagram illustrating one display example of the second payment method designation screen 600. As illustrated, the second payment method designation screen 600 includes a total area 601 of registered items, an electronic money area 602, a post-payment balance area 603, and a payment key area 604. The same information as in the total area 102 and the electronic money area 103 of the registration screen 100 are displayed in the total area 601 and the electronic money area 602. However, the post-payment balance of the electronic money area 103 is not paid with the electronic money, and thus the electronic money balance is displayed. The balance of the price if the price of the merchandise to be purchased is paid with the balance of the electronic money is displayed on the post-payment balance area 603. However, if the shortage processing key of the “separate payment of full amount” is input, the price is not paid with the electronic money, the price of merchandise to be purchased is displayed without change, on the post-payment balance area 603. For example, soft keys for designating three types of payment methods of the cash, the credit card, and the code settlement, that is, a so-called cash key, a so-called credit key, and a so-called code settlement key are displayed on the payment key area 604. The electronic money key is not displayed. Otherwise, the electronic money key is grayed out and disabled.

In addition, FIG. 28 illustrates the second payment method designation screen 600 if the customer who cannot pay the full amount of the price with the electronic money because the balance of the electronic money is 1,000 yen while the price of the merchandise to be purchased is 5,500 yen, inputs the shortage processing key of the “separate payment of full amount”. The customer inputs the key on which a desired payment method is displayed.

The processor 21 that displays the second payment method designation screen 600 waits for the designation of any one of the payment methods in ACT 68. If any one of the keys displayed on the payment key area 604 is input to designate a payment method, the processor 21 determines the payment status corresponding to the payment method in ACT 69. Specifically, if the cash payment is designated by the input of the cash key, the processor 21 sets the payment status to be “01”. If the credit card payment is designated by the input of the credit key, the processor 21 sets the payment status to be “02”. If the code settlement payment is designated by the input of the code settlement key, the processor 21 sets the payment status to be “03”.

In this manner, the processor 21 that determines the payment status proceeds to ACT 51 of FIG. 10. The processor 21 performs the processes of ACTS 51 to 55 described above in the same manner.

In the waiting state of ACTS 64 to 66, if the shortage processing key of the “separate payment after deduction” is input, the processor 21 proceeds from ACT 65 to ACT 70. The processor 21 sets the screen of the touch panel 24 to be a second payment method designation screen 600-2 in ACT 70. The second payment method designation screen 600-2 if the shortage processing key of the “separate payment after deduction” is input has the same configuration as the second payment method designation screen 600 if the shortage processing key of the “separate payment of full amount” is input. However, the post-payment balance of the electronic money area 103 becomes 0 yen. In addition, the amount of money obtained by deducting the balance of the electronic money from the price of the merchandise to be purchased is displayed on the post-payment balance area 603. For example, in case of the screen example illustrated in FIG. 28, if the second payment method designation screen 600-2 is displayed, the post-payment balance of the electronic money area 103 becomes 0 yen, and the amount of money in the post-payment balance area 603 becomes 4,500 yen.

The processor 21 that displays the second payment method designation screen 600-2 waits for the designation of any one of the payment methods in ACT 71. Also, if any one of the keys displayed on the payment key area 604 is input to designate the payment method, the processor 21 determines the payment status corresponding to the payment method in ACT 72. Specifically, if the cash payment is designated by the input of the cash key, the processor 21 sets the payment status to be “11”. If the credit card payment is designated by the input of the credit key, the processor 21 sets the payment status to be “12”. If code settlement payment is designated by the input of the code settlement key, the processor 21 sets the payment status to be “13”.

In this manner, the processor 21 that determines the payment status proceeds to ACT 51 of FIG. 10. The processor 21 performs the processes of ACTS 51 to 55 described above in the same manner.

In the waiting states of ACTS 64 to 66, if the shortage processing key of the “payment after charging” is input, the processor 21 proceeds from ACT 64 to ACT 73. The processor 21 sets the screen of the touch panel 24 to be the deposit amount designation screen 200 (see FIG. 24) described above in ACT 73. Also, the processor 21 waits for the designation of the deposit amount in ACT 74. If the deposit amount is designated by the input of the deposit key, the processor 21 stores the designated deposit amount in ACT 75.

The processor 21 sets the payment status to be “14” in ACT 76 and proceeds to ACT 51 of FIG. 10. The processor 21 performs the same processes of ACTS 51 to 55 described above. However, in addition to the user ID and the payment status of “14”, the electronic money ID stored in the electronic money ID area 233 and the deposit amount stored in the process of ACT 75 are included in the payment request command.

If the accounting barcode is completely erased in ACT 55, the processor 21 ends the information process of the procedure illustrated in the flowcharts of FIGS. 7 to 11.

### Operation Description of Mobile Controller

Next, by using the flowcharts of FIGS. 12 to 19, the main operation of the mobile controller 16 when an electronic money member does shopping at the store by using the information terminal 2 linked to electronic money is described.

The processor 91 of the mobile controller 16 waits for the request command in ACT 101 of FIG. 12. Once the request command is received via the communication interface 95, the processor 91 identifies the type of the request command in ACTS 102 to 108 and performs the information process in response to this type.

### Operation Description if Check-In Request Command is Received

If the request command is the check-in request command issued from the information terminal 2, the processor 91 proceeds from ACT 102 to ACT 111 of FIG. 13. The processor 91 detects the user ID from the check-in request command as ACT 111. The processor 91 generates the transaction file 921 for the customer identified by the user ID in ACT 112. The user ID detected in ACT 111 is stored in the transaction file 921.

The processor 91 checks whether the check-in request command is issued from an information terminal 2 linked to electronic money in ACT 113. If the electronic money ID is included in the check-in request command, the processor 91 recognizes that the check-in request command is issued from an information terminal 2 linked to electronic money.

If the check-in request command is issued from the information terminal 2 linked to electronic money, the processor 91 proceeds from ACT 113 to ACT 114. The processor 91 stores the electronic money ID included in the check-in request command in the transaction file 921 generated in the process of ACT 112 in ACT 114.

The processor 91 accesses the electronic money server 3 and acquires the balance (initial/present balance) of the electronic money identified by the corresponding electronic money ID in ACT 115. Also, the processor 91 stores the balance of the electronic money in the transaction file 921 in ACT 116.

Thereafter, the processor 91 transmits the permission response command to the information terminal 2 in ACT 117. In the above, the processor 91 ends the information process of the procedure illustrated in the flowchart of FIG. 13. The balance of the electronic money acquired in the process of ACT 115 is included in the permission response command at this time. The data of the balance is stored in the balance memory 221 of the information terminal 2.

If the check-in request command is issued from an information terminal 2 that is not linked to electronic money, the processor 91 proceeds from ACT 113 to ACT 117. The processor 91 transmits the permission response command to the information terminal 2 in ACT 117. Since the processor 91 skips the processes of ACTS 114 to 116, the balance of the electronic money is not included in the permission response command.

### Operation Description if Merchandise Registration Request Command is Received

If the request command is the merchandise registration request command issued from the information terminal 2, the processor 91 proceeds from ACT 103 to ACT 121 of FIG. 14. The processor 91 detects the user ID from the merchandise registration request command in ACT 121. Also, the processor 91 selects the transaction file 921 that stores the user ID in ACT 122. Hereinafter, the transaction file 921 that stores the user ID acquired from the command is referred to as the target transaction file 921.

The processor 91 detects the merchandise code from the merchandise registration request command in ACT 123. Also, the processor 91 acquires merchandise data of the merchandise identified by the merchandise code such as the merchandise name and the unit price in ACT 124. The processor 91 generates the merchandise sales data including the merchandise code, the merchandise name, the unit price, the number of items to be sold, the sold amount, and the like based on the merchandise data in ACT 125 and stores the merchandise sales data in the target transaction file 921. In addition, the processor 91 calculates the total amount of the registered merchandise based on the merchandise sales data stored in the target transaction file 921.

The processor 91 checks whether the merchandise registration request command is issued from an information terminal 2 linked to electronic money in ACT 127. If the electronic money ID and the balance of the electronic money are stored in the target transaction file 921, the processor 91 recognizes that the merchandise registration request command is issued from an information terminal 2 linked to electronic money. If the merchandise registration request command is issued from the information terminal 2 linked to electronic money, the processor 91 proceeds from ACT 127 to ACT 128. The processor 91 calculates the post-payment balance in ACT 128. That is, the processor 91 subtracts the total amount calculated in the process of ACT 126 from the balance of the electronic money stored in the target transaction file 921.

Thereafter, the processor 91 transmits the permission response command to the information terminal 2 in ACT 129. With the above, the processor 91 ends the information process of the procedure illustrated in the flowchart of FIG. 14. Together with the data of the target transaction file 921, the post-payment balance calculated in the process of ACT 128 is included in the permission response command at this point. The data of this post-payment balance is stored in the post-payment balance memory 222 of the information terminal 2.

If the merchandise registration request command is issued from an information terminal 2 that is not linked to electronic money, the processor 91 proceeds from ACT 127 to ACT 129. The processor 91 transmits the permission response command to the information terminal 2 in ACT 129. Since the processor 91 skips the process of ACT 128, the post-payment balance is not included in the permission response command.

### Operation Description if Charging Request Command is Received

If the request command is the charging request command issued from the information terminal 2, the processor 91 proceeds from ACT 104 to ACT 131 of FIG. 15. The processor 91 detects the user ID from the charging request command thereof in ACT 131. Also, the processor 91 selects the transaction file 921 that stores the user ID, that is, the target transaction file 921 in ACT 132.

The processor 91 detects the electronic money ID from the target transaction file 921 in ACT 133. In addition, the processor 91 detects the deposit amount from the charging request command in ACT 134. The processor 91 generates charge data in association with the electronic money ID and the deposit amount in ACT 135. The processor 91 stores the charge data in the target transaction file 921 in ACT 136.

The processor 91 generates the charging code in ACT 137. The charging code is data for converting the user ID detected in the process of ACT 131 into a barcode. The processor 91 transmits the permission response command to the information terminal 2 in ACT 138. With the above, the processor 91 ends the information process of the procedure illustrated in the flowchart of FIG. 15. The charging code generated in the process of ACT 137 is included in the permission response command at this point. This charging code is displayed on the touch panel 24 of the information terminal 2 in the form of a barcode.

### Operation Description if Balance Request Command is Received

If the request command is the balance request command issued from the information terminal 2, the processor 91 proceeds from ACT 105 to ACT 141 of FIG. 16. The processor 91 detects the user ID from the balance request command in ACT 141. Also, the processor 91 selects the transaction file 921 that stores the user ID, that is, the target transaction file 921 in ACT 142.

The processor 91 detects the electronic money ID from the target transaction file 921 in ACT 143. The processor 91 that detects the electronic money ID accesses the electronic money server 3 and acquires the balance of the electronic money identified by the corresponding electronic money ID in ACT 144. The processor 91 updates the balance of the electronic money stored in the target transaction file 921 to the balance acquired in the process of ACT 144 in ACT 145. In addition, the processor 91 clears the charge data from the target transaction file 921 in ACT 146.

Thereafter, the processor 91 transmits the permission response command to the information terminal 2 in ACT 147. With the above, the processor 91 ends the information process of the procedure illustrated in the flowchart of FIG. 16. The balance of the electronic money acquired in the process of ACT 144 is included in the permission response command at this time. The data of this balance is stored in the balance memory 221 of the information terminal 2.

### Operation Description if Payment Request Command is Received

If the request command is the payment request command issued from the information terminal 2, the processor 91 proceeds from ACT 106 to ACT 151 of FIG. 17. The processor 91 detects the user ID from the payment request command in ACT 151. Also, the processor 91 selects the transaction file 921 that stores the user ID, that is, the target transaction file 921, in ACT 152.

The processor 91 detects the payment status from the payment request command in ACT 153. The processor 91 stores the payment status in the target transaction file 921 in ACT 154.

The processor 91 checks whether the payment status is “14” in ACT 155. If the payment status is “14”, that is, the customer whose the balance of the electronic money is insufficient selects the process of the “payment after charging”, the processor 91 acquires the electronic money ID and the deposit amount from the payment request command in ACT 156. Also, the processor 91 generates the charge data in association with the electronic money ID and the deposit amount in ACT 157. The processor 91 stores the charge data in the target transaction file 921 in ACT 158.

If the payment status is not “14”, the processor 91 skips the processes of ACTS 156 to 158. If the process of ACT 158 is completed or the payment status is not “14”, the processor 91 generates the accounting code in ACT 159. The accounting code is data for converting the user ID detected in the process of ACT 151 into a barcode. The processor 91 transmits the permission response command to the information terminal 2 in ACT 160. With the above, the processor 91 ends the information process of the procedure illustrated in the flowchart of FIG. 17. The accounting code generated in the process of ACT 155 is included in the permission response command at this time. This accounting code is displayed on the touch panel 24 of the information terminal 2 in the form of a barcode.

### Operation Description if Charge Data Request Command is Received

If the barcode of the charging code displayed on the touch panel 24 of the information terminal 2 is scanned with the scanner 56 of the charger 11, the charge data request command is transmitted from the charger 11 to the mobile controller 16. The user ID obtained from the charging code is included in the charge data request command.

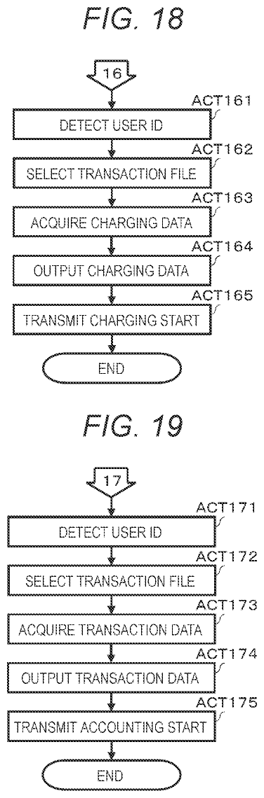

If the request command is a charge data request command issued from the charger 11, the processor 91 proceeds from ACT 107 to ACT 161 of FIG. 18. The processor 91 detects the user ID in charge data request command in ACT 161. Also, the processor 91 selects the transaction file 921 that stores the user ID, that is, the target transaction file 921 in ACT 162.

The processor 91 acquires the charge data from the target transaction file 921 in ACT 163. The processor 91 outputs the charge data to the charger 11 in ACT 164. In ACT 165, the processor 91 transmits the charging start command by using the user ID (detected in the process of ACT 161) for determining the transmission destination (information terminal 2). With the above, the processor 91 ends the information process of the procedure illustrated in the flowchart of FIG. 18.

The charging start command is received by the information terminal 2 corresponding to the user ID in the user ID area 232. In the information terminal 2 that receives the charging start command, the barcode of the charging code displayed on the touch panel 24 is erased.

### Operation Description if Transaction Data Request Command is Received

If the barcode of the accounting code displayed in the touch panel 24 of the information terminal 2 is scanned with the scanner 77 of the settlement terminal 12, the transaction data request command is transmitted from the settlement terminal 12 to the mobile controller 16. The user ID obtained from the accounting code is included in the transaction data request command.

If the request command is the transaction data request command issued from the settlement terminal 12, the processor 91 proceeds from ACT 108 to ACT 171 of FIG. 19. The processor 91 detects the user ID from the transaction data request command in ACT 171. Also, the processor 91 selects the transaction file 921 that stores the user ID, that is, the target transaction file 921 in ACT 172.

The processor 91 acquires the transaction data from the target transaction file 921 in ACT 173. The transaction data includes an electronic money ID stored in ACT 114 of FIG. 13, the balance of the electronic money stored in ACT 116 of FIG. 13 and updated in ACT 145 of FIG. 16, the merchandise sales data stored in ACT 125 of FIG. 14, and the payment status stored in ACT 154 of FIG. 17. The processor 91 outputs the transaction data to the settlement terminal 12 in ACT 174. In ACT 175, the processor 91 transmits the accounting start command using the user ID detected in the process of ACT 171 to set the transmission destination. With the above, the processor 91 ends the information process of the procedure illustrated in the flowchart of FIG. 19.

The accounting start command is received by the information terminal 2 corresponding to the user ID in the user ID area 232. From the information terminal 2 that receives the accounting start command, the barcode of the accounting code displayed on the touch panel 24 is erased.

In addition, if a command other than the request command is received, the processor 91 performs the process in response to such command in ACT 109.

The processor 91 of the mobile controller 16 functions as the first acquisition means 911 upon receiving the merchandise registration request command from the information terminal 2 and performing the processes of ACTS 121 to 125 of FIG. 14. In addition, the processor 91 functions as the post-payment balance output means 917 by performing the processes of ACTS 126 to 129. The processor 91 functions as the second acquisition means 912 upon receiving the charging request command from the information terminal 2 and performs the processes of ACTS 131 to 136 of FIG. 15. The processor 91 functions as the accounting code output means 913 upon receiving the payment request command from the information terminal 2 and performs the processes of ACTS 151 to 156 of FIG. 17. The processor 91 functions as the first provision means 914 upon receiving the transaction data request command from the settlement terminal 12 and performs the processes of ACTS 171 to 175 of FIG. 19. The processor 91 functions as the charging code output means 915 upon receiving the charging request command from the information terminal 2 and performs the processes of ACTS 131 to 138 of FIG. 15. The processor 91 functions as the second provision means 916 upon receiving the charge data request command from the charger 11 and performs the processes of ACTS 161 to 165 of FIG. 18.

### Operation Description of Charger

FIG. 20 is a flowchart illustrating a procedure performed by the processor 51 of the charger 11. The charging start key is displayed on the touch panel 55 of the charger 11 in a default state. The processor 51 waits for the input of the charging start key in ACT 201.

If the customer (an electronic money member) who wants to charge the electronic money performs a touch operation on the charging start key, the processor 51 proceeds from ACT 201 to ACT 202. The processor 51 causes the touch panel 55 to display the deposit reception screen in ACT 202. The deposit reception screen is a screen for instructing a deposition method by the customer. Examples of the customer include a first-type customer selects charge key of an information terminal 2 linked to electronic money and to whom the barcode of the charging code is displayed on the touch panel 24 and a second-type customer who is not a first-type customer. The deposit reception screen displays an image for instructing the scanner 56 to scan the barcode of the charging code to the first-type customer. An image for instructing the reader/writer 58 to read the data of the electronic money card is displayed to the second-type customer.

The processor 51 that displays the deposit reception screen waits for the reading of the data of the electronic money card with the reader/writer 58 in ACT 203 or the scanning of the barcode of the charging code with the scanner 56 in ACT 204. In the waiting state in ACTS 203 and 204, if the data of the electronic money card is read with the reader/writer 58, that is, if the second-type customer causes the reader/writer 58 to read the data of the electronic money card, the processor 51 proceeds from ACT 203 to ACT 205. The processor 51 causes the screen of the touch panel 55 to be the deposit amount designation screen in ACT 205. The deposit amount designation screen is a screen on which the deposit key displayed on the deposit key area 203 of the deposit amount designation screen 200 illustrated in FIG. 24 is disposed.

The processor 51 that displays the deposit amount designation screen waits for the designation of the deposit amount in ACT 206. If the deposit amount is designated by the operation of the second-type customer, the processor 51 proceeds to ACT 211.

In the waiting state of ACTS 203 and 204, when the barcode of the charging code is scanned by the scanner 56, that is, the first-type customer scans the barcode of the charging code with the scanner 56, the processor 51 proceeds from ACT 204 to ACT 207. The processor 51 detects the user ID from the barcode scanned in ACT 207. The processor 51 transmits the charge data request command to the mobile controller 16 in ACT 208. The charge data request command is transmitted to the mobile controller 16 via the communication network 18. The user ID detected in the process of ACT 207 is included in the charge data request command.

The processor 51 waits for the charge data in ACT 209. As described with reference to FIG. 18, the mobile controller 16 that receives the charge data request command detects the charge data from the transaction file that stores the user ID included in the charge data request command. Also, the mobile controller 16 transmits the charge data thereof to the charger 11 that sent the charge data request command.

The processor 51 that receives the charge data stores the charge data thereof, that is, the electronic money ID and the deposit amount in ACT 210. Also, the processor 51 proceeds to ACT 211.

In this manner, when the charge data is stored in ACT 210 or the deposit amount is designated in ACT 206, the processor 51 proceeds to ACT 211. The processor 51 causes the screen of the touch panel 55 to be a charging execution screen in ACT 211. The charging execution screen is a screen for enabling the first-type customer or the second-type customer to check the deposit amount designated with the deposit amount designation screen or the deposit amount of the charge data. An execution key for instructing the execution of charging is displayed on the charging execution screen.

The processor 51 waits for an input of the execution key in ACT 212. When the execution key is input by the first-type customer or the second-type customer, the processor 51 performs the charging process in ACT 213. The charging process is a process of notifying the electronic money server 3 of the electronic money ID associated with the information read from the electronic money card (or the electronic money ID of the charge data) and the deposit amount in response to the input of money to the money receiving unit 59. According to this notification, in the electronic money server 3, the deposit amount is added to the electronic money balance associated with the electronic money ID.

After this, the processor 51 drives the printer 57 and controls the dispensing of the charge receipt in ACT 214. According to this control, a charge receipt (on which the balance before the charging, the deposit amount, and the balance after the charging are printed) is dispensed from the printer 57.

The processor 51 then ends the information processing of the procedure illustrated in the flowchart of FIG. 20. The charger 11 returns to the default or idle state. For example, the processor 51 causes the touch panel 55 to display the charging start key and waits for an input of the operation.

### Operation Description of Settlement Terminal

FIGS. 21 and 22 are flowcharts illustrating the procedures performed by the processor 71 of the settlement terminal 12. A guide screen is displayed on the touch panel 76 of the settlement terminal 12 in the default state. The guide screen is a screen for guiding the customer to scan the barcode of the accounting code displayed on the touch panel 24 of the information terminal 2 using the scanner 77. The processor 71 waits for the scanning of the barcode of the accounting code with the scanner 77 in ACT 301.

After the customer selects one of the payment methods from the first payment method designation screen 300 of the information terminal 2, the displayed barcode is scanned with the scanner 77 of the settlement terminal 12 (ACT 301; YES). When the barcode (accounting code) is scanned with the scanner 77, the processor 71 detects the user ID from the barcode (ACT 302). The processor 71 transmits the transaction data request command to the mobile controller 16 in ACT 303. The transaction data request command is transmitted to the mobile controller 16 via the communication network 18. The user ID detected in the process of ACT 302 is included in the transaction data request command.

The processor 71 then waits for the transaction data in ACT 304. As described with reference to FIG. 19, the mobile controller 16 that receives a transaction data request command acquires the transaction data from the transaction file matching the user ID included in the transaction data request command. The mobile controller 16 then transmits the transaction data to the settlement terminal 12 after transaction data request command is received.

The processor 71 receives the transaction data and then acquires the payment status from the transaction data in ACT 305. The processor 71 checks whether the payment status is “01”, “02”, “03” or “04” in ACTS 306 to 309.

When the payment status is “01”, the processor 71 proceeds from ACT 306 to ACT 310. The processor 71 performs the cash settlement process in ACT 310. When the payment status is “02”, the processor 71 proceeds from ACT 307 to ACT 311. The processor 71 performs the credit settlement process in ACT 311. If the payment status is “03”, the processor 71 proceeds from ACT 308 to ACT 312. The processor 71 performs the code settlement process in ACT 312.

If the payment status is “04”, the processor 71 proceeds from ACT 309 to ACT 313. The processor 71 acquires the balance of electronic money together with the electronic money ID from the transaction data in ACT 313. The processor 71 then performs the electronic money settlement process in ACT 314 based on the electronic money balance. If the electronic money settlement process is successfully completed, the processor 71 notifies a balance update for the electronic money associated with the electronic money ID in ACT 315. The electronic money server 3 reduces the electronic money balance for the electronic money ID in response to the balance update notification. The processor 71 then ends the information process if the payment status was “01”, “02”, “03” or “04”.

If the payment status is not “01”, “02”, “03” or “04”, the processor 71 next checks whether the payment status is “11”, “12”, “13” or “14” in ACTS 321 to 323 of FIG. 22.

If the payment status is “11”, the processor 71 proceeds from ACT 321 to ACT 324. The processor 71 acquires the balance of the electronic money for the electronic money ID in ACT 324. The processor 71 calculates, in ACT 325, the remaining balance after electronic money payment by deducting the electronic money balance from the total amount due in the transaction data. The processor 71 then performs a cash settlement process on the remaining balance of the total amount in ACT 326. Thereafter, the processor proceeds to ACT 333.

If the payment status is “12”, the processor 71 proceeds from ACT 322 to ACT 327. The processor 71 acquires the electronic money balance the transaction data in ACT 327. The processor 71 then calculates the remaining balance of the total amount due after the electronic money payment by deducting the electronic money balance from the remaining total amount due in ACT 328. The processor 71 next performs a credit settlement process for the remaining balance of the total amount due in ACT 329. Thereafter, the processor proceeds to ACT 333.

If the payment status is “13”, the processor 71 proceeds from ACT 323 to ACT 330. The processor 71 acquires the electronic money balance from the transaction data in ACT 330. The processor 71 then calculates the remaining balance of the total amount due after the electronic money payment by deducting the electronic money balance from the total amount due in the transaction data in ACT 331. The processor 71 then performs a code settlement process for the remaining balance of the total amount in ACT 332. Thereafter, the processor proceeds to ACT 333.

In this manner, if the payment status is “11”, “12” or “13”, the processor 71 performs the settlement process for paying a portion of the total amount due with electronic money and then paying the rest with cash, a credit card or code settlement and then proceeds to ACT 333. In ACT 333, the processor 71 notifies a balance update for the electronic money account identified by the electronic money ID acquired from the transaction data. The notification is sent to the electronic money server 3. According to this notification, the electronic money payment amount is subtracted from the electronic money balance associated with the electronic money ID. That is, in this case, the balance of the electronic money becomes 0 yen. With the above, the processor 71 ends the information process if the payment status is “11”, “12”, or “13”.

If the payment status is “14”, the processor 71 proceeds from ACT 323 to ACT 334. The processor 71 acquires the charge data from the transaction data in ACT 334. Also, the processor 71 causes the screen of the touch panel 76 to be the charging execution screen in ACT 335. The charging execution screen is a screen for enabling the customer to check the deposit amount to be added to the electronic money account. The execution key for instructing the execution of a charging is displayed on the charging execution screen.

The processor 51 waits for a selection (pressing) of the execution key in ACT 336. If the execution key is selected by the customer, the processor 51 performs the charging process in ACT 337. The charging process is a process of sending an electronic money ID and a deposit amount to the electronic money server 3 in response to the input of the money to the automatic change dispenser. According to this notification to the electronic money server 3, the deposit amount is added to the electronic money balance associated with electronic money ID.

The processor 51 may then acquire the electronic money balance after the charging from the electronic money server 3 in ACT 338. The processor 71 then performs, in ACT 339, an electronic money settlement process for paying the full amount due using the electronic money balance after the charging. The processor 71 then ends the information processing.

### Effect of Store System

If the customer is an electronic money member and performs a merchandise registration operation by using an information terminal 2 linked to electronic money when purchasing the merchandise on the sales floor, the registration screen 100 is displayed on the touch panel 24 of the information terminal 2. On the registration screen 100, the balance of the electronic money, the post-payment balance (if it is assumed that the full price of the merchandise is paid with the electronic money) are displayed together with the merchandise names of the registered merchandise, the prices, the total amount due, and the like. Accordingly, the customer can easily check not only the balance of the electronic money but also the post-payment balance if the price of the registered merchandise was to be paid with electronic money.

If the customer completes the shopping on the sales floor and selects the payment key of the registration screen 100, the screen of the touch panel 24 transitions from the registration screen 100 to the first payment method designation screen 300. Also, the customer then selects a key for a desired payment method. Then, the accounting barcode is displayed on the touch panel 24, and the customer moves to the cashier area of the store. The customer then scans the accounting barcode with the scanner 77 of an available settlement terminal 12. According to this operation, the transaction data of the customer is transmitted from the mobile controller 16 to the settlement terminal 12.

The payment status is included in the transaction data sent from the mobile controller 16. If the payment status is “01”, that is, the customer designates the cash payment, the cash settlement process is performed at the settlement terminal 12. If the payment status is “02”, that is, the customer designates the credit card payment, the credit settlement process is performed at the settlement terminal 12. If the payment status is “03”, that is, the customer designates the code settlement payment, the code settlement process is performed at the settlement terminal 12. If the payment status is “04”, that is, the customer designates the electronic money payment, the electronic money settlement process is performed at the settlement terminal 12.

In this manner, with the store system 1, a preprocessing operation designating the payment method to be used at the settlement terminal 12 can be performed by operation of the information terminal 2 before the customer moves to the cashier area or a settlement terminal 12. Accordingly, the occupancy time of a settlement terminal 12 for each customer is shortened as compared with that in the related art requiring the selection of payment method to be made by the customer at a settlement terminal 12 or the like.

Also, if the customer designates an electronic money payment, the settlement terminal 12 can perform the settlement process by using the balance of the electronic money included in the transaction data. Therefore, the processing time at the settlement terminal 12 can be shortened compared with that in the related art in which the settlement terminal 12 or the like must itself access the electronic money server 3 to acquire the available balance of the electronic money. As a result, the occupancy time of a settlement terminal 12 or the like for each customer can be shortened compared with that in the related art.

In addition, if the customer designates an electronic money payment but the available balance is insufficient to complete the transaction, an insufficient balance notification screen 400 can be displayed on the touch panel 24. According to the insufficient balance notification screen 400, the customer knows that the electronic money balance is insufficient for full payment before the operations at the settlement terminal 12.

If the customer receiving the insufficient balance notification screen 400 then selects the payment key from the insufficient balance notification screen 400 to a shortage processing designation screen 500 is then displayed. The customer then designates one of the three processing methods: “payment after charging”, the “separate payment after deduction”, and the “separate payment of full amount”.

If the customer designates the “separate payment of full amount” or the “separate payment after deduction”, the screen of the touch panel 24 transitions from the shortage processing designation screen 500 to the second payment method designation screen 600, where customer designates a payment method other than the electronic money payment to be used. For example, if the customer designates cash payment, the payment status becomes “01” or “11”. If the customer designates credit card payment, the payment status becomes “02” or “12”. If the customer designates code settlement payment, the payment status becomes “03” or “13”. The accounting barcode is then displayed on the touch panel 24.

At the settlement terminal 12, if the payment status is “01”, “02”, or “03”, cash settlement process, credit card settlement process, or code settlement process is performed as appropriate. If the payment status is “11”, “12”, or “13”, the electronic money settlement process is performed up to the available balance of the electronic money, and then cash settlement process, credit card settlement process, or code settlement process is performed on the rest of the transaction balance as appropriate.

In this manner, according to the store system 1, if the balance of the electronic money is insufficient, a preprocessing operation of designating an alternative processing method and designating the payment method which is to be performed by the settlement terminal 12 can be performed by operating the information terminal 2 before the customer moves to the cashier area. Therefore, the occupancy time of a settlement terminal 12 for each is shortened compared with that in the related art.

If the customer designates the “payment after charging”, the screen of the touch panel 24 transitions from the shortage processing designation screen 500 to the deposit amount designation screen 200. Here, the customer designates the deposit amount to be added to the electronic money balance. Then, the payment status becomes “14” and accounting barcode is displayed on the touch panel 24.

If the payment status is “14”, the charging execution screen for enabling the customer to confirm the designated deposit amount by operating the information terminal 2 is displayed on the settlement terminal 12 that reads the accounting barcode. Here, the customer selects the execution key. Then, the deposit amount is added to the electronic money account the corresponding customer. Also, at the settlement terminal 12, the electronic money settlement process can be performed with the electronic money balance after the charging.

In this manner, according to the store system 1, the preprocessing operation of designating the deposit amount which would otherwise be performed at the settlement terminal 12 when the charging is performed because the electronic money is insufficient can be performed by operating the information terminal 2 before the customer moves to the cashier area. Accordingly, the occupancy time of a settlement terminal 12 for each customer is shortened compared with that in the related art.

Accordingly, the occupancy time of a settlement terminal 12 for each customer is greatly shortened compared with that in the related art, and thus the congestion of the cashier area can be relieved.

On the registration screen 100 of the information terminal 2, the post-payment balance is also displayed together with the available balance of the electronic money. The customer who intends to add money to the electronic money account by using the charger 11 during the shopping selects the charge key of the registration screen 100. Then, the screen of the touch panel 24 transitions from the registration screen 100 to the deposit amount designation screen 200, and thus the customer designates the deposit amount to be added to the electronic money account. The charge barcode is then displayed on the touch panel 24, and the customer performs the scanning operation on the charge barcode with the scanner 56 of an unoccupied charger 11. According to this operation, the charge data is transmitted from the mobile controller 16 to the charger 11. The electronic money ID of the customer and the deposit amount designated by the customer using the information terminal 2 are included in the charge data.

On the charger 11, the charging execution screen is displayed, and the customer selects the execution key and the charging process is performed at the charger 11.

In this manner, according to the store system 1, a preprocessing operation that designates the deposit amount to be performed at the charger 11 can be performed with the information terminal 2 before the customer arrives at the charger 11. Accordingly, the occupancy time of a charger 11 for each customer can be shortened compared with that in the related art. As a result, the congestion of the charger 11 can be relieved.

### Modifications

According to an embodiment, the mobile controller 16 functions as the first acquisition means 911, the second acquisition means 912, the accounting code output means 913, the first provision means 914, the charging code output means 915, the second provision means 916, and the post-payment balance output means 917. As another embodiment, a portion or all of these described functions may be performed by a device other than the mobile controller 16, for example, the information terminal 2 may itself perform such functions in whole or in part. For example, the store system 1 may be configured so that the information terminal 2 provides the first acquisition means 911, the second acquisition means 912, the accounting code output means 913, the charging code output means 915, and the post-payment balance output means 917, and the mobile controller 16 provides the first provision means 914 and the second provision means 916.

According to an embodiment, the mobile controller 16 is connected to the communication network 18. As another embodiment, the function of the mobile controller 16 may be provided by a cloud server on the Internet. In this case, the cloud server on the Internet is connected to the wide area network 4 and provides the described functions of the mobile controller 16. The functions of the mobile controller 16 may be upscaled by use of the cloud server.

In an embodiment, a smart phone is used as the information terminal 2. In other examples, the information terminal 2 may be a mobile terminal that is owned by the store and lent to the customer, a tablet-type terminal attached to a shopping cart (a cart terminal), or the like. In such cases, the customer can achieve the same effect as in the above-described embodiments by performing an operation to link an electronic money ID to the mobile terminal or the cart terminal before shopping/payment.

In an embodiment, the charger 11 and the settlement terminal 12 are described as examples of a shared device that is used by multiple customer or users. However, in other embodiments, the shared device may be another type of device other than the charger 11 or the settlement terminal 12 for which the inputting of certain data for a user of the device may be provided via the user's information terminal rather than at the shared device itself. For example, the shared device in other embodiments may be a ticket vending machine or an ATM for which the effect of shortening individual user occupancy times at the shared device can be achieved by pre-provision of such information or data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A store system, comprising:
an access point configured to connect to an information terminal that is operated by a customer on a sales floor;
a settlement terminal configured to process payments for merchandise registered by the customer for purchase using the information terminal; and
a mobile controller connected to the access point and configured to:
acquire sales data for the merchandise registered by the customer for purchase using the information terminal;
acquire preprocessing data from the information terminal in association with the sales data;
output an accounting code to the information terminal, the accounting code causing the settlement terminal to begin a settlement process when read by the settlement terminal from the information terminal; and
provide the sales data and the preprocessing data to the settlement terminal after the reading of the accounting code.

2. The store system according to claim 1, wherein the preprocessing data includes an electronic money account identification (ID) associated with the customer.

3. The store system according to claim 1, wherein the preprocessing data includes a payment method selection of the customer.

4. The store system according to claim 3, wherein the settlement terminal proceeds, after the reading of the accounting code, to the displaying of a user screen specific to the payment method selection of the customer included in the preprocessing data.

5. The store system according to claim 1, wherein the preprocessing data includes an electronic money account identification (ID) associated with the customer and an initial balance associated with the electronic money account ID.

6. The store system according to claim 1, wherein the preprocessing data includes an electronic money account identification (ID) associated with the customer, an initial balance associated with the electronic money account ID, and a remaining balance associated with the electronic money account ID, the remaining balance reflecting the subtraction of the total price for the merchandise registered in the sales data.

7. The store system according to claim 6, wherein, if the remaining balance is zero, the settlement terminal displays a electronic money account charging screen after reading of the accounting code.

8. The store system according to claim 1, further comprising:
an electronic money account charger to configured to allow the customer to add money to an electronic money account, wherein
the mobile controller is further configured to:
output a charging code to the information terminal, the charging code being readable by the electronic money account charger; and
provide an electronic money account identification (ID) and an intended deposit amount entered by user operation of the information terminal and provided to the mobile controller as preprocessing data.

9. A mobile controller for a store system, the mobile controller comprising:
a communication interface to connect to an access point configured to connect to an information terminal operated by a customer on a sales floor and a settlement terminal that processes payments for merchandise registered for purchase by the customer using the information terminal; and
a processor configured to:
acquire sales data for the merchandise registered by the customer for purchase using the information terminal;
acquire preprocessing data from the information terminal in association with the sales data;
output an accounting code to the information terminal, the accounting code causing the settlement terminal to begin a settlement process when read by the settlement terminal from the information terminal; and
provide the sales data and the preprocessing data to the settlement terminal after the reading of the accounting code.

10. The mobile controller according to claim 9, wherein the preprocessing data includes an electronic money account identification (ID) associated with the customer.

11. The mobile controller according to claim 9, wherein the preprocessing data includes a payment method selection of the customer.

12. The mobile controller according to claim 11, wherein the settlement terminal proceeds, after the reading of the accounting code, to the displaying of a user screen specific to the payment method selection of the customer included in the preprocessing data.

13. The mobile controller according to claim 9, wherein the preprocessing data includes an electronic money account identification (ID) associated with the customer and an initial balance associated with the electronic money account ID.

14. The mobile controller according to claim 9, wherein the preprocessing data includes an electronic money account identification (ID) associated with the customer, an initial balance associated with the electronic money account ID, and a remaining balance associated with the electronic money account ID, the remaining balance reflecting the subtraction of the total price for the merchandise registered in the sales data.

15. The mobile controller according to claim 14, wherein, if the remaining balance is zero, the settlement terminal displays a electronic money account charging screen after reading of the accounting code.

16. The mobile controller according to claim 9, wherein the processor is further configured to:
output a charging code to the information terminal, the charging code being readable by an electronic money account charger; and
provide an electronic money account identification (ID) and an intended deposit amount entered by user operation of the information terminal as preprocessing data.

17. A non-transitory, computer-readable medium storing program instructions which when executed by a mobile controller in a store system causes the mobile controller to perform a method comprising:
acquiring sales data for merchandise registered by a customer for purchase using an information terminal;
acquiring preprocessing data from the information terminal in association with the sales data;
outputting an accounting code to the information terminal, the accounting code causing a settlement terminal to begin a settlement process when read by the settlement terminal from the information terminal; and
providing the sales data and the preprocessing data to the settlement terminal after the reading of the accounting code.

18. The non-transitory, computer-readable medium according to claim 17, wherein the preprocessing data includes an electronic money account identification (ID) associated with the customer.

19. The non-transitory, computer-readable medium according to claim 17, wherein the preprocessing data includes a payment method selection of the customer.

20. The non-transitory, computer-readable medium according to claim 17, wherein the preprocessing data includes an electronic money account identification (ID) associated with the customer, an initial balance associated with the electronic money account ID, and a remaining balance associated with the electronic money account ID, the remaining balance reflecting the subtraction of the total price for the merchandise registered in the sales data.
